(19) United States
(12) Patent Application Publication
(10) Pub. No.: US 2025/0258057 A1
(43) Pub. Date: Aug. 14, 2025

(54) CRACK INSPECTION APPARATUS, AND CRACK MONITORING SYSTEM

(71) Applicant: Mitsubishi Electric Corporation, Tokyo (JP)

(72) Inventors: Nobuhiko KAJINAMI, Tokyo (JP); Norihiko HANA, Tokyo (JP); Ryutaro KAWAGUCHI, Tokyo (JP)

(73) Assignee: Mitsubishi Electric Corporation, Tokyo (JP)

(21) Appl. No.: 18/992,330

(22) PCT Filed: Jul. 13, 2022
(86) PCT No.: PCT/JP2022/027559

§ 371 Date: Jan. 8, 2025

(51) Int. Cl. G01M 5/00

(52) U.S. Cl. CPC G01M 5/0033; G01M 5/0008

(57) ABSTRACT

A crack inspection apparatus includes an input unit that is a structure data acquisition unit that acquires structure data indicating characteristics of a structure that is to be inspected, a geometry measuring unit that is a crack information acquisition unit that acquires crack information indicating the geometry of a crack that has occurred in the structure, an opening amount measuring unit that is a loaded crack information acquisition unit that acquires loaded crack information indicating the amount of opening of the crack with a load applied to the crack, and an estimation unit that estimates a fracture mechanics parameter from the relationship between the load applied to the crack and the amount of opening, based on the structure data, the crack information, and the loaded crack information, the fracture mechanics parameter quantitatively indicating a growth inhibition effect on the crack.

### FIELD

The present disclosure relates to a crack inspection apparatus, a crack monitoring system, and a crack inspection method for evaluating the state of a crack occurring in a structure.

### BACKGROUND

In the presence of an object such as an oxide in a crack occurred in a structure, it is known that the amount of change in the opening and closing of the crack is reduced, reducing the growth rate of the crack. This phenomenon is called the crack closure phenomenon due to the wedge force action of the crack, the wedge effect, or the like. A technique using the wedge effect is now under development. For such a technique, a paste having high-hardness fine particles and oil mixed together is applied to a crack to allow the fine particles to enter the crack, thereby inhibiting fatigue crack growth.

Patent Literature 1 discloses an example of a method of evaluating a crack growth inhibition effect using the wedge effect. For the evaluation method disclosed in Patent Literature 1, thermoelastic temperature variations at a crack tip are measured before and after repair, and an evaluation value, which is the ratio of the amplitudes of the thermoelastic temperature variations before and after the repair, is evaluated with a view to evaluating the crack growth inhibition effect.

### CITATION LIST

### Patent Literature

Patent Literature 1: Japanese Patent Application Laid-open No. 2015-31565

### SUMMARY OF INVENTION

### Problem to be Solved by the Invention

The above conventional technique is on the precondition that thermoelastic temperature variations are measured before and after the inhibition of crack growth. In other words, it is impossible to measure the pre-growth-inhibition thermoelastic temperature variations when the growth of a crack is inhibited by a natural phenomenon, for example, when an object such as a corrosion product or a fretting oxide is formed in the crack. This results in the problem of difficulty evaluating the crack growth inhibition effect.

The present disclosure has been made in view of the above. It is an object of the present disclosure to provide a crack inspection apparatus that can easily evaluate the crack growth inhibition effect even when crack growth is inhibited by a natural phenomenon.

### Means to Solve the Problem

To solve the above problem and achieve the object, a crack inspection apparatus of the present disclosure comprises: a structure data acquisition unit to acquire structure data indicating characteristics of a structure that is to be inspected; a crack information acquisition unit to acquire crack information indicating a geometry of a crack occurred in the structure; a loaded crack information acquisition unit to acquire loaded crack information indicating an amount of opening of the crack with a load applied to the crack; and an estimation unit to estimate a fracture mechanics parameter from a relationship between the load applied to the crack and the amount of opening, on a basis of the structure data, the crack information, and the loaded crack information, the fracture mechanics parameter quantitatively indicating a growth inhibition effect on the crack.

### Effects of the Invention

The present disclosure has an advantage of providing the crack inspection apparatus that can easily evaluate the crack growth inhibition effect even when the crack growth is inhibited by the natural phenomenon.

### BRIEF DESCRIPTION OF DRAWINGS

FIG. 1 is a diagram illustrating a functional configuration of a crack inspection apparatus according to a first embodiment.

FIG. 2 is a flowchart for explaining an inspection process performed by the crack inspection apparatus illustrated in FIG. 1.

FIG. 3 is a diagram illustrating structure data acquired by an input unit illustrated in FIG. 1.

FIG. 4 is a diagram schematically illustrating the relationship between the growth rate of a crack occurring in a structure made of steel and the stress intensity factor range.

FIG. 5 is a flowchart for explaining the operation of a geometry measuring unit illustrated in FIG. 1.

FIG. 6 is a diagram illustrating a first example of a method of measuring the amount of opening of a crack.

FIG. 7 is a diagram illustrating a second example of a method of measuring the amount of opening of a crack.

FIG. 8 is a diagram illustrating an example of a load application method for a load application unit illustrated in FIG. 1.

FIG. 9 is a flowchart for explaining the operation of an opening amount measuring unit illustrated in FIG. 1.

FIG. 10 is a flowchart for explaining the operation of an estimation unit illustrated in FIG. 1.

FIG. 11 is a diagram schematically illustrating the relationship between the amount of opening of a crack and a load.

FIG. 12 is a diagram for explaining the relationship between the amount of opening and a load when the load is smaller than a crack opening load.

FIG. 13 is a diagram for explaining the relationship between the amount of opening and a load when the load is larger than the crack opening load.

FIG. 14 is a diagram illustrating a functional configuration of a crack inspection apparatus according to a first modification of the first embodiment.

FIG. 15 is a flowchart for explaining the operation of the crack inspection apparatus illustrated in FIG. 14.

FIG. 16 is a diagram illustrating a functional configuration of a crack inspection apparatus according to a second modification of the first embodiment.

FIG. 17 is a flowchart for explaining the operation of the crack inspection apparatus illustrated in FIG. 16.

FIG. 18 is a diagram illustrating a functional configuration of a crack inspection apparatus according to a second embodiment.

FIG. 19 is a flowchart for explaining the operation of the crack inspection apparatus illustrated in FIG. 18.

FIG. 20 is an explanatory diagram of growth inhibition treatment performed by a repair unit illustrated in FIG. 18.

FIG. 21 is a diagram illustrating a functional configuration of a crack inspection apparatus according to a first modification of the second embodiment.

FIG. 22 is a flowchart for explaining the operation of the crack inspection apparatus illustrated in FIG. 21.

FIG. 23 is a diagram illustrating a functional configuration of a crack inspection apparatus according to a third embodiment.

FIG. 24 is a flowchart for explaining the operation of the crack inspection apparatus illustrated in FIG. 23.

FIG. 25 is a diagram illustrating the relationships between the numbers of repetitions of load application performed by a repeated load application unit in FIG. 23 and a crack growth inhibition effect.

FIG. 26 is a diagram illustrating a functional configuration of a crack inspection apparatus according to a first modification of the third embodiment.

FIG. 27 is a flowchart for explaining the operation of the crack inspection apparatus illustrated in FIG. 26.

FIG. 28 is a diagram illustrating a functional configuration of a crack inspection apparatus according to a second modification of the third embodiment.

FIG. 29 is a flowchart for explaining the operation of the crack inspection apparatus illustrated in FIG. 28.

FIG. 30 is a flowchart for explaining the operation of a load application determination unit illustrated in FIG. 28.

FIG. 31 is a diagram illustrating a configuration of a fatigue crack monitoring system according to a fourth embodiment.

FIG. 32 is a diagram illustrating an example of data stored in a storage unit illustrated in FIG. 31.

FIG. 33 is a sequence diagram for explaining the operation of the fatigue crack monitoring system illustrated in FIG. 31.

FIG. 34 is a diagram illustrating a configuration of a fatigue crack monitoring system according to a first modification of the fourth embodiment.

FIG. 35 is a diagram illustrating a configuration of a fatigue crack monitoring system according to a fifth embodiment.

FIG. 36 is a sequence diagram for explaining the operation of the fatigue crack monitoring system illustrated in FIG. 35.

FIG. 37 is a diagram illustrating a configuration of a fatigue crack monitoring system according to a first modification of the fifth embodiment.

FIG. 38 is a diagram for explaining a first example of respective hardware configurations of the crack inspection apparatus and the fatigue crack monitoring system.

FIG. 39 is a diagram for explaining a second example of respective hardware configurations of the crack inspection apparatus and the fatigue crack monitoring system.

### DESCRIPTION OF EMBODIMENTS

A crack inspection apparatus, a crack monitoring system, and a crack inspection method according to embodiments of the present disclosure will be hereinafter described in detail with reference to the drawings.

### First Embodiment

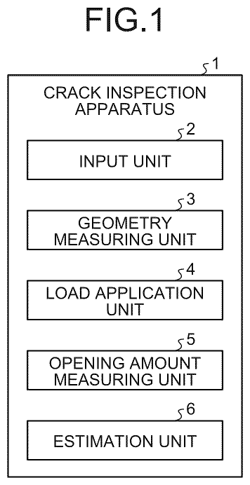

FIG. 1 is a diagram illustrating a functional configuration of a crack inspection apparatus 1 according to a first embodiment. The crack inspection apparatus 1 includes an input unit 2, a geometry measuring unit 3, a load application unit 4, an opening amount measuring unit 5, and an estimation unit 6. The crack inspection apparatus 1 has the function of inspecting the state of a crack occurred in a structure to be inspected.

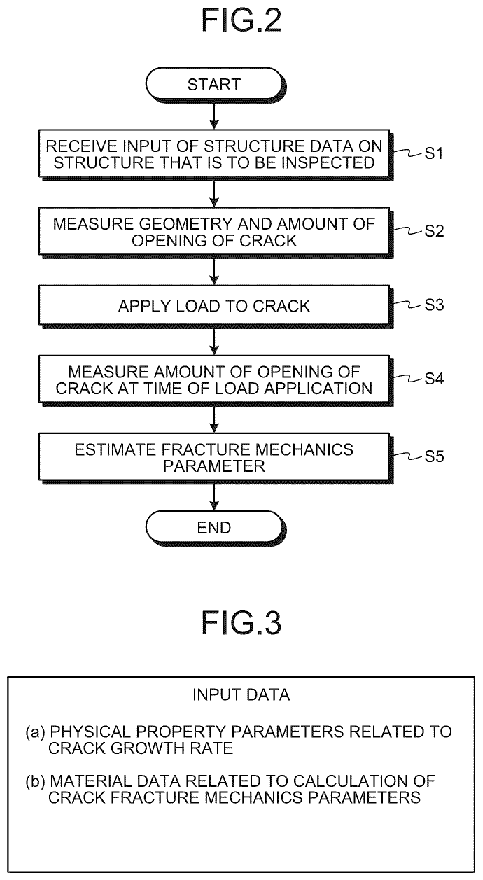

First, an outline of an inspection process performed by the crack inspection apparatus 1 will be described. FIG. 2 is a flowchart for explaining the inspection process performed by the crack inspection apparatus 1 illustrated in FIG. 1.

The input unit 2 of the crack inspection apparatus 1 receives the input of structure data indicating characteristics of a structure that is to be inspected (step S1). The structure data includes, for example, material data indicating the material of the structure that is to be inspected. Next, using the geometry measuring unit 3, the crack inspection apparatus 1 measures the geometry and the amount of opening of a crack occurred in the structure that is to be inspected (step S2).

Using the load application unit 4, the crack inspection apparatus 1 applies a predetermined load to the crack (step S3). With the load applied to the crack, the crack inspection apparatus 1 measures the amount of opening of the crack at the time of load application, using the opening amount measuring unit 5 (step S4). The estimation unit 6 of the crack inspection apparatus 1 estimates the effective stress intensity factor range as a fracture mechanics parameter indicating the state of the crack (step S5).

The following describes details of the configuration and operation of each unit of the crack inspection apparatus 1.

FIG. 3 is a diagram illustrating structure data acquired by the input unit 2 illustrated in FIG. 1. The input unit 2 acquires input data indicating characteristics of a structure that is to be inspected. The input data includes data (a) and (b) described below.
(a) Physical property parameters related to the crack growth rate
(b) Material data related to calculation of crack fracture mechanics parameters

The input unit 2 may include operating devices such as a mouse and a keyboard for inputting signals to a computer according to an operator's operations, or may include peripheral equipment for inputting stored data prepared in advance to a computer. The input data acquired by the input unit 2 is data indicating the characteristics of the structure that is to be inspected. Such data is also referred to as structure data. The input unit 2 is an example of a structure data acquisition unit that acquires the structure data. Next, the relationship between the stress intensity factor range and the crack growth rate will be described, following which the structure data acquired by the input unit 2 will be described in detail.

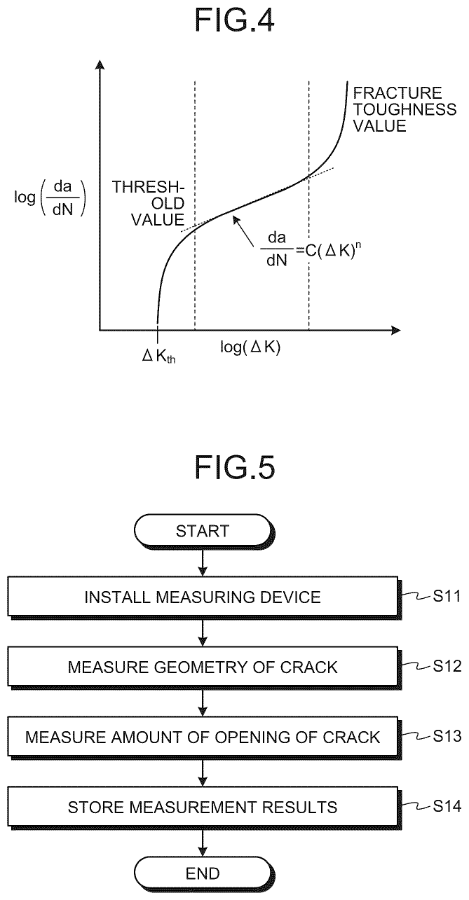

FIG. 4 is a diagram schematically illustrating the relationship between the growth rate of a crack occurring in a structure made of steel and the stress intensity factor range. The relationship between the growth rate of the crack occurred in the structure made of steel and the stress intensity factor range is represented by a curve illustrated in FIG. 4. The horizontal axis in FIG. 4 is the logarithm of the stress intensity factor range “ΔK”. The vertical axis in FIG. 4 is the logarithm of the crack growth rate “da/dN”. It is known that the crack growth rate “da/dN” decreases as the stress intensity factor range ΔK decreases, and that the crack stops growing when the value of the stress intensity factor range “ΔK” becomes less than or equal to the threshold stress intensity factor range “ΔKₜₕ”. The unit of the stress intensity factor range and the threshold stress intensity factor range is expressed as “MPa√m”, and the unit of the crack growth rate is expressed as “m/cycle”.

Thus, an estimation formula for the crack growth rate “da/dN” is expressed by formulas (1) and (2) below.

$$\begin{matrix}da / dN = {C ( Δ K )}^{n} & Δ K > Δ {K}_{th}\end{matrix} \qquad ( 1 )$$

$$\begin{matrix}da / dN = 0 & Δ K \leq Δ {K}_{th}\end{matrix} \qquad ( 2 )$$

C and n are material parameters determined by the structure. Formula (1) applies in the range of ΔK>ΔKₜₕ. Formula (2) applies in the range of ΔK≤ΔKₜₕ, and indicates that the crack stops growing when the stress intensity factor range ΔK becomes less than or equal to the threshold stress intensity factor range ΔKₜₕ. Alternatively, the estimation formula for the crack growth rate “da/dN” may be expressed by formula (3) below.

$$da / dN = C ( {( Δ K )}^{n} - {( Δ {K}_{th} )}^{n} ) \qquad ( 3 )$$

“Physical property parameters related to the crack growth rate” illustrated in FIG. 3 correspond to the material parameters C and n in formulas (1) and (3) above, and the threshold stress intensity factor range ΔKₜₕ. For these physical property parameters, for example, “Guidelines for fatigue design of steel structures” disclosed by the Japanese Society of Steel Construction or the like may be used. “Material data related to calculation of crack fracture mechanics parameters” illustrated in FIG. 3 is stiffness parameters used for structural analysis, and includes the Young's modulus, Poisson's ratio, etc. of the structure.

FIG. 5 is a flowchart for explaining the operation of the geometry measuring unit 3 illustrated in FIG. 1. The geometry measuring unit 3 acquires crack information indicating the geometry and the amount of opening of a crack occurred in the structure that is to be inspected. The geometry measuring unit 3 is an example of a crack information acquisition unit that acquires the crack information.

The geometry measuring unit 3 has a measuring device installed thereon for the crack occurred in the structure to be inspected (step S11). Next, the geometry measuring unit 3 measures the geometry of the crack with the measuring device (step S12). The geometry measuring unit 3 measures the geometry of the crack, using a nondestructive inspection method so as not to deteriorate the condition of the structure. Examples of the nondestructive inspection method include an X-ray measuring method, an ultrasonic flaw detection method, and a current flaw detection method. The geometry measuring unit 3 measures the amount of opening of the crack with the measuring device (step S13). Step S13 is performed after step S12 herein, but the processing in step S12 and the processing in step S13 may be performed simultaneously in parallel. Next, the geometry measuring unit 3 stores the measurement results in the storage unit (step S14).

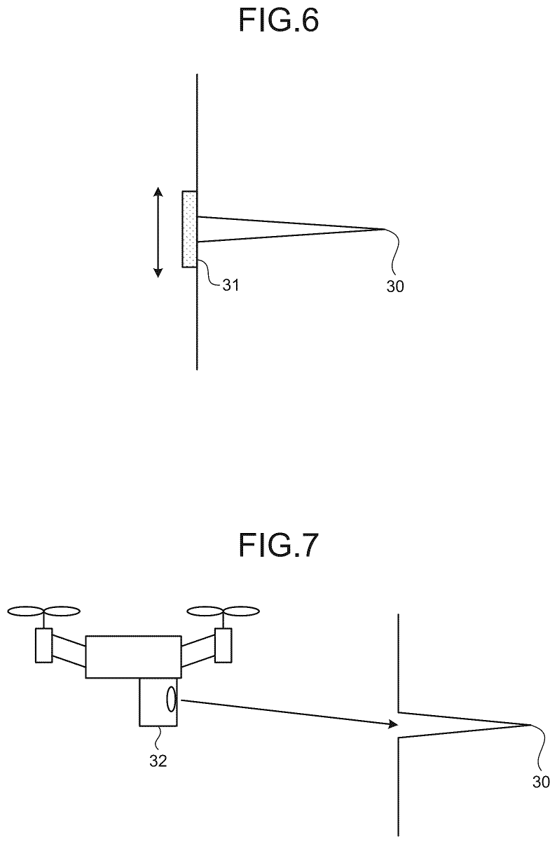

FIG. 6 is a diagram illustrating a first example of a method of measuring the amount of opening of the crack. In the first example, a sensor 31 for measuring the amount of opening is directly attached to the opening of a crack 30 to thereby measure the amount of opening of the crack. The sensor 31 for measuring the amount of opening may be a fiber-optic sensor that measures the amount of deformation of an object from light propagating through the fiber. A fiber-optic sensor is also called an optical strain sensor, an optical-fiber sensor, a Fiber Bragg Grading (FBG) sensor, or the like. A fiber-optic sensor, which has its high tolerance to environmental loads such as high humidity and high temperature, is usable under various environments, such that the sensor is left attached to the opening of the crack to thereby monitor the state over an extended time period.

FIG. 7 is a diagram illustrating a second example of a method of measuring the amount of opening of the crack. In the second example, the amount of opening of the crack is measured using a captured image of the crack 30 occurred in the structure that is to be inspected. In the second example illustrated in FIG. 7, an imaging device 32 for capturing an image is mounted on a drone to thereby facilitate the acquisition of even the amount of opening of a crack occurred in, for example, a high place, i.e., a place that cannot be easily accessed by a person. Furthermore, it becomes possible to measure the amounts of opening of a plurality of cracks by the single imaging device 32 at once, so that the workability of geometry measurement can be increased, and the device cost for geometry measurement can be reduced. Although FIG. 7 illustrates an example in which the imaging device 32 is mounted on the drone, the imaging device 32 may be fixed to a measurement jig installed on the ground.

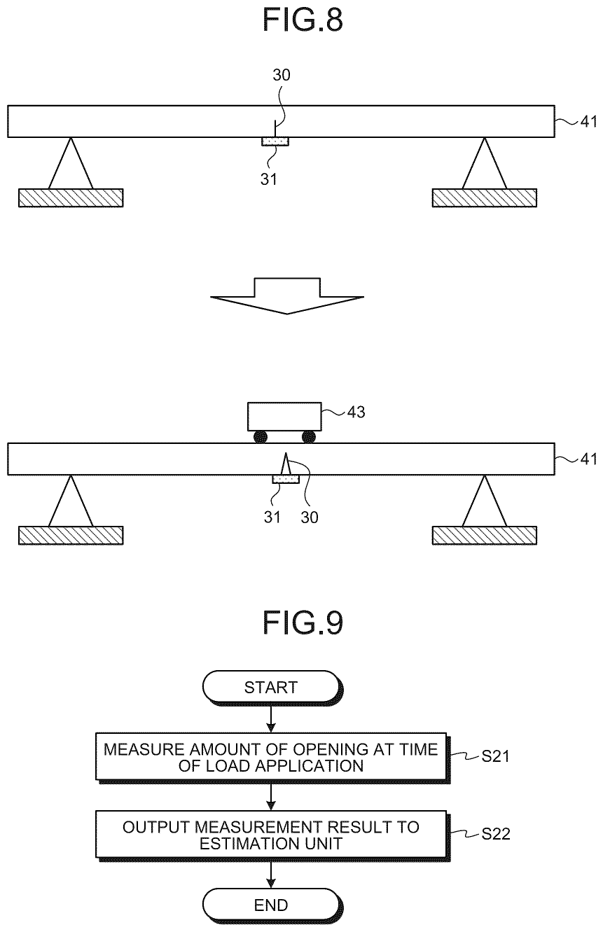

FIG. 8 is a diagram illustrating an example of a load application method for the load application unit 4 illustrated in FIG. 1. The example illustrated herein is where the structure to be inspected is a bridge 41, and a predetermined load is applied to the crack 30 occurred in the bridge 41 so as to open the crack 30. The sensor 31 illustrated in FIG. 6 is installed on the crack 30. The load application unit 4 can cause an inspection vehicle 43 having a known weight to travel on the bridge 41 to apply the load to the crack 30. For processing by the estimation unit 6, data on the load applied by the load application unit 4 needs to be synchronized in time series with data on the amount of opening measured by the opening amount measuring unit 5.

FIG. 9 is a flowchart for explaining the operation of the opening amount measuring unit 5 illustrated in FIG. 1. The opening amount measuring unit 5 measures the amount of opening at the time of load application in the same way as the geometry measuring unit 3 measures the amount of opening. Specifically, the opening amount measuring unit 5 may measure the amount of opening, using the sensor 31 illustrated in FIG. 6 or may measure the amount of opening, using the imaging device 32 illustrated in FIG. 7.

The opening amount measuring unit 5 measures the amount of opening at the time of load application with the load application unit 4 applying the load to the crack (step S21). Then, the opening amount measuring unit 5 outputs, to the estimation unit 6, data obtained by synchronizing the amount of opening that is the measurement result with the data on the applied load in time series to the estimation unit 6 (step S22).

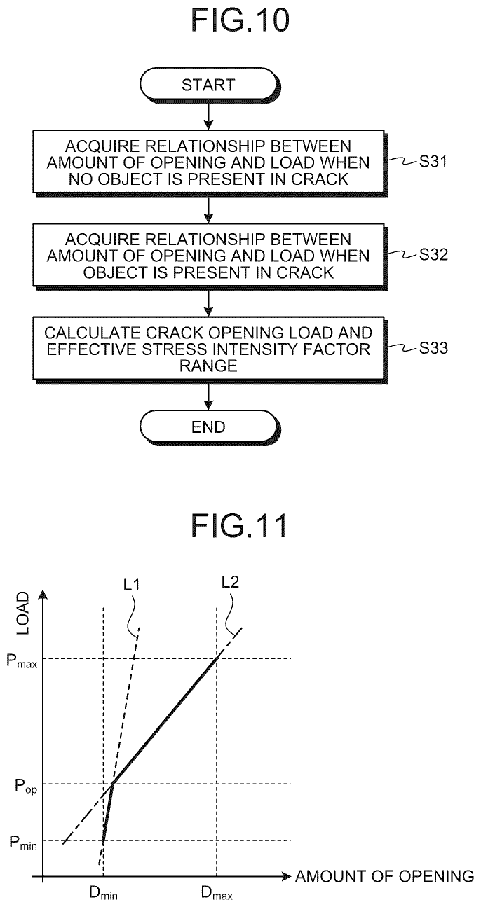

FIG. 10 is a flowchart for explaining the operation of the estimation unit 6 illustrated in FIG. 1. The estimation unit 6 acquires the relationship between the amount of opening and the load when no object is present in the crack (step S31). The expression “in the crack” herein, which refers to the interior of a space created by the occurrence of the crack, refers to the interior of a space between surfaces newly produced in the structure by the occurrence of the crack. Next, the estimation unit 6 acquires the relationship between the amount of opening and the load when an object is present in the crack (step S32). The relationship between the amount of opening and the load acquired by the estimation unit 6 in step S32 is acquired from the data obtained by synchronizing the amount of opening measured by the opening amount measuring unit 5, with the data on the applied load in time series. Furthermore, the estimation unit 6 calculates a crack opening load Pₒₚ and the effective stress intensity factor range from the acquired relationship between the amount of opening and the load (step S33). The crack opening load Pₒₚ is a load to fully open the crack.

FIG. 11 is a diagram schematically illustrating the relationship between the amount of opening of the crack and the load. A straight line L1 indicated by a broken line in FIG. 11 is a straight line obtained by extrapolating the relationship between the load and the amount of opening of the crack in a load range of Pₒₚ to Pₘᵢₙ in which range the crack is closed in the presence of the object in the crack. Pₘᵢₙ is a minimum applied load to the crack. A straight line L2 indicated by a dash-dotted line in FIG. 11 is a straight line obtained by extrapolating the relationship between the amount of opening of the crack and the load in the absence of the object in the crack. In step S31 of FIG. 10, the estimation unit 6 acquires “the relationship between the amount of opening and the load when no object is present in the crack” as represented by the straight line L2.

When an object is present in the crack, the crack does not close under a specific load or less. Thus, if the object has an ideal geometry matching the geometry of the crack, there is a point of change at which point a bend occurs under a certain load, as indicated by a solid line in FIG. 11. This phenomenon is due to the action of the wedge effect that is one of crack closure phenomena. The wedge effect is also called the bridging effect or the crack closure phenomenon due to a wedge force action mechanism. The load at the point of change in the slope is the crack opening load Pₒₚ in the crack closure phenomenon, and is the load at which the crack is fully opened. Since the crack is closed in a load range equal to or less than the crack opening load Pₒₚ, the load range of Pₒₚ or less does not contribute to the growth of the crack. When the object is present in the crack, therefore, a load range that contributes to the growth of the crack decreases from the range of Pₘₐₓ to Pₘᵢₙ to the range of Pₘₐₓ to Pₒₚ in FIG. 11. Pₘₐₓ is a maximum applied load. This decrease in the load range contributing to the growth of the crack leads to a reduction in the stress concentration range at the crack tip, so that the growth of the crack is inhibited.

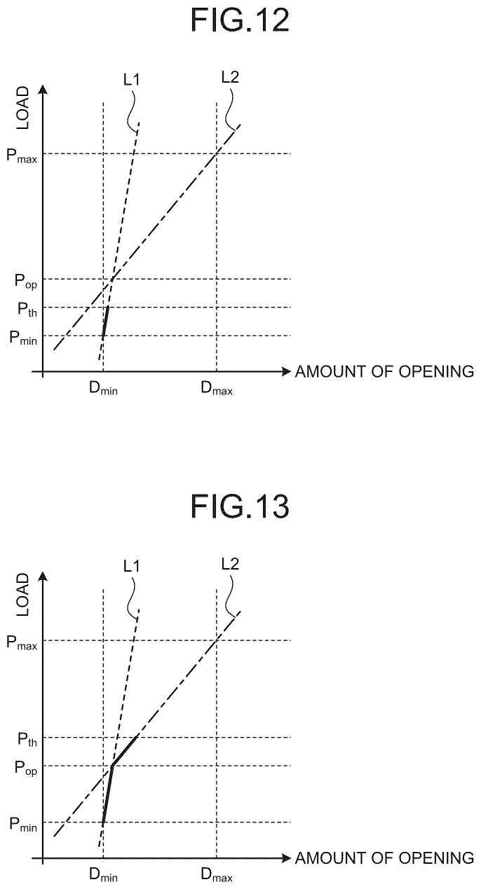

A description will be made herein as to the relationship between the load and the amount of opening when a predetermined load Pₜₕ is applied to the crack. FIG. 12 is a diagram for explaining the relationship between the amount of opening and the load when the load Pₜₕ is smaller than the crack opening load Pₒₚ. FIG. 13 is a diagram for explaining the relationship between the amount of opening and the load when the load Pₜₕ is larger than the crack opening load Pₒₚ.

First, when the load Pₜₕ is smaller than the crack opening load Pₒₚ, the relationship between the amount of opening and the load obtained with the load Pₜₕ applied to the crack is represented by a solid line in FIG. 12. In this case, the above-mentioned point of change does not appear in the obtained relationship. For this reason, the estimation unit 6 calculates the straight line L1 by extrapolating the obtained relationship, and calculates the intersection of the straight line L1 and the straight line L2 to thereby calculate the crack opening load Pₒₚ. The straight line L2 can be obtained by creating a structural analysis model from the crack geometry data acquired in advance by the geometry measuring unit 3 and the material data of the structure included in the structure data acquired by the input unit 2, and performing numerical analysis.

When the load Pₜₕ is larger than the crack opening load Pₒₚ, the relationship between the amount of opening and the load obtained with the load Pₜₕ applied to the crack is represented by a solid line in FIG. 13. In this case, the above-mentioned point of change appears in the obtained relationship. The estimation unit 6 can therefore calculate the load at the point of change appearing in the obtained relationship as the crack opening load Pₒₚ.

Next, a method by which the estimation unit 6 calculates the stress intensity factor range will be described. The stress intensity factor range ΔK is calculated for each crack geometry, using formula (4) below.

$$Δ K = {K}_{max} - {K}_{min} \qquad ( 4 )$$

Kₘₐₓ, which is a maximum value of the stress intensity factor under the action of the maximum applied load Pₘₐₓ, is expressed by formula (5) below.

$${K}_{max} = {P}_{max} \times f ( a ) \qquad ( 5 )$$

f(a), which is a function of the depth of the crack determined by the geometry of the crack, is acquired at the time of geometry measurement by the geometry measuring unit 3. a is the length (m) of the crack. Kₘᵢₙ, which is a minimum value of the stress intensity factor under the action of the minimum applied load Pₘᵢₙ, is expressed by formula (6) below.

$${K}_{min} = {P}_{min} \times f ( a ) \qquad ( 6 )$$

Using formulas (4) to (6), the estimation unit 6 can calculate the stress intensity factor range ΔK from the function f(a) of the depth of the crack obtained by the geometry measuring unit 3 and the load acting on the crack. When the crack closure phenomenon due to the wedge effect occurs and the crack opening load Pₒₚ exists, the estimation unit 6 can calculate the effective stress intensity factor range ΔK_{eff} that contributes to crack growth, using formula (7) below.

$$Δ {K}_{eff} = {K}_{max} - {K}_{op} \qquad ( 7 )$$

Kₒₚ, which is the stress intensity factor under the action of the crack opening load Pₒₚ, is expressed by formula (8) below.

$${K}_{op} = {P}_{op} \times f ( a ) \qquad ( 8 )$$

The effective stress intensity factor range ΔK_{eff} is calculated using formula (7). The calculated effective stress intensity factor range ΔK_{eff} is substituted into “ΔK” in formulas (1) and (3), thereby calculating the growth rate “da/dN” of the crack whose growth is inhibited by the occurrence of the wedge effect. As described above, if the crack opening load Pₒₚ can be estimated, the effective stress intensity factor range ΔK_{eff} can be calculated, and further, the crack growth rate “da/dN” can be derived. Using a display screen or the like, the estimation unit 6 may output estimation results such as the effective stress intensity factor range ΔK_{eff} and the crack growth rate “da/dN”.

As described above, the crack inspection apparatus 1 includes: the input unit 2 that is the structure data acquisition unit that acquires structure data indicating characteristics of the material of a structure that is to be inspected; the geometry measuring unit 3 that is the crack information acquisition unit that acquires crack information indicating the geometry and the amount of opening of a crack occurred in the structure; the opening amount measuring unit 5 that is a loaded crack information acquisition unit that acquires loaded crack information indicating the amount of opening of the crack with a load applied to the crack; and the estimation unit 6 that estimates the effective stress intensity factor range that is a fracture mechanics parameter from the relationship between the load applied to the crack and the amount of opening, based on the structure data, the crack information, and the loaded crack information, the fracture mechanics parameter indicating the state of the crack. Consequently, even when the maximum load Pₘₐₓ of actual load does not act, the effective stress intensity factor range ΔK_{eff} can be derived by calculating the crack opening load Pₒₚ from the relationship between the amount of opening and the applied load. This makes it possible to perform an inspection for evaluating the state of the crack, without allowing the crack to grow. Further, since the crack growth rate “da/dN” can be determined by using the effective stress intensity factor range ΔK_{eff} and formulas (1) and (3), the state of the crack can be quantitatively evaluated.

Furthermore, the above method makes it possible to derive the effective stress intensity factor range ΔK_{eff} by calculating the crack opening load Pₒₚ from the relationship between the amount of opening and the applied load, and thus to evaluate a crack growth inhibition effect even for a crack inhibited in growth as a result of the presence of an object in the crack due to a natural phenomenon.

### (First Modification)

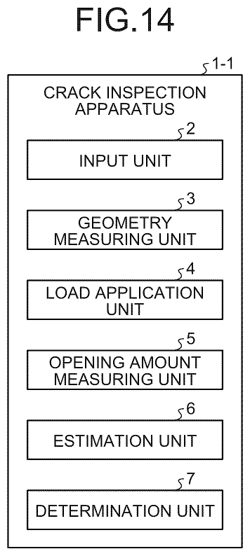

FIG. 14 is a diagram illustrating a functional configuration of a crack inspection apparatus 1-1 according to a first modification of the first embodiment. The crack inspection apparatus 1-1 includes the input unit 2, the geometry measuring unit 3, the load application unit 4, the opening amount measuring unit 5, the estimation unit 6, and a determination unit 7. The crack inspection apparatus 1-1 includes the determination unit 7 in addition to the configuration of the crack inspection apparatus 1. The following mainly describes the difference from the crack inspection apparatus 1, and omits the description of the same components as those of the crack inspection apparatus 1.

The determination unit 7 determines the presence or absence of the growth of the crack, based on the effective stress intensity factor range and the structure data, the effective stress intensity factor range being a fracture mechanics parameter. Specifically, the determination unit 7 can determine the presence or absence of the growth of the crack by comparing the effective stress intensity factor range ΔK_{eff} calculated by the estimation unit 6 with the threshold stress intensity factor range ΔKₜₕ included in the structure data.

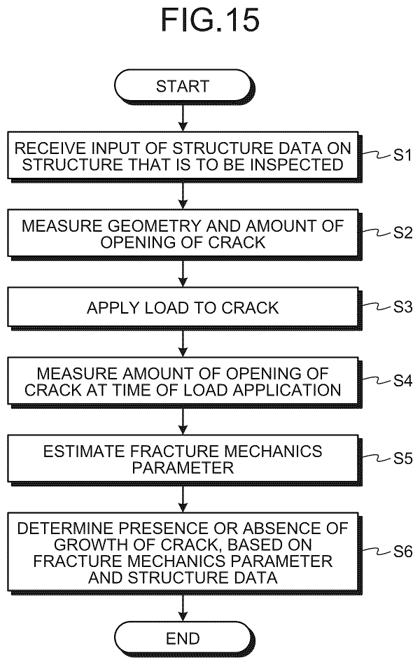

FIG. 15 is a flowchart for explaining the operation of the crack inspection apparatus 1-1 illustrated in FIG. 14. The input unit 2 of the crack inspection apparatus 1-1 receives the input of structure data indicating characteristics of a structure that is to be inspected (step S1). The structure data includes, for example, material data indicating the material of the structure that is to be inspected. Next, using the geometry measuring unit 3, the crack inspection apparatus 1-1 measures the geometry and the amount of opening of a crack occurred in the structure that is to be inspected (step S2).

Using the load application unit 4, the crack inspection apparatus 1-1 applies a predetermined load to the crack (step S3). With the load applied to the crack, the crack inspection apparatus 1-1 measures the amount of opening of the crack at the time of load application, using the opening amount measuring unit 5 (step S4). The estimation unit 6 of the crack inspection apparatus 1-1 estimates the effective stress intensity factor range as a fracture mechanics parameter indicating the state of the crack (step S5). The determination unit 7 of the crack inspection apparatus 1-1 determines the presence or absence of the growth of the crack, based on the fracture mechanics parameter estimated by the estimation unit 6 and the structure data received by the input unit 2 (step S6). Specifically, the determination unit 7 compares the effective stress intensity factor range ΔK_{eff} estimated by the estimation unit 6 with the threshold stress intensity factor range ΔKₜₕ included in the structure data received by the input unit 2. When the effective stress intensity factor range ΔK_{eff} is less than or equal to the threshold stress intensity factor range ΔKₜₕ, the determination unit 7 can determine that the crack has not grown, that is, the crack remains stagnant. When the effective stress intensity factor range ΔK_{eff} is larger than the threshold stress intensity factor range ΔKₜₕ, the determination unit 7 can determine that the crack has grown.

By including the determination unit 7, the crack inspection apparatus 1-1 can check the presence or absence of the growth of a crack that is to be inspected, in addition to the effects of the crack inspection apparatus 1. If the crack inspection apparatus 1 outputs the result of determination made by the determination unit 7 by means of display or the like, the presence or absence of the growth of a crack that is to be inspected can be checked at the time of inspection, so that the necessity of reinspection can be determined on the spot, which effectively reduces the work load.

### (Second Modification)

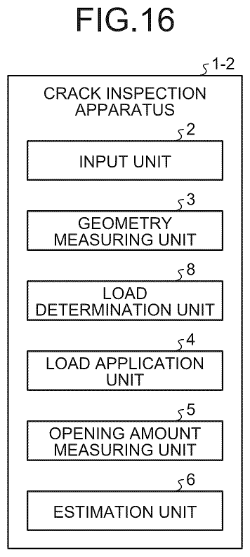

FIG. 16 is a diagram illustrating a functional configuration of a crack inspection apparatus 1-2 according to a second modification of the first embodiment. The crack inspection apparatus 1-2 includes the input unit 2, the geometry measuring unit 3, a load determination unit 8, the load application unit 4, the opening amount measuring unit 5, and the estimation unit 6. The crack inspection apparatus 1-2 includes the load determination unit 8 in addition to the configuration of the crack inspection apparatus 1. The following mainly describes the difference from the crack inspection apparatus 1, and omits the description of the same components as those of the crack inspection apparatus 1.

The load determination unit 8 sets the load to be applied to the crack by the load application unit 4, to a value at which the crack does not grow. If the crack grows when the load is applied to the crack at the time of inspection, the degree of damage to the structure is increased, and the estimation unit 6 may evaluate the state of the crack with reduced accuracy. In view of this, a load at which the crack does not grow is set as the load to be applied at the time of inspection. Specifically, the stress intensity factor range when a certain load is applied can be calculated using formulas (4) to (8). For this reason, the load determination unit 8 calculates a load at which the stress intensity factor range ΔK is equal to the threshold stress intensity factor range ΔKₜₕ, and sets the load to be applied to the crack by the load application unit 4, to a value less than or equal to the calculated load. The range expressed by “less than or equal to the threshold stress intensity factor range ΔKₜₕ” is an example of a growth stagnation range indicating the range of the fracture mechanics parameter in which range the crack stops growing.

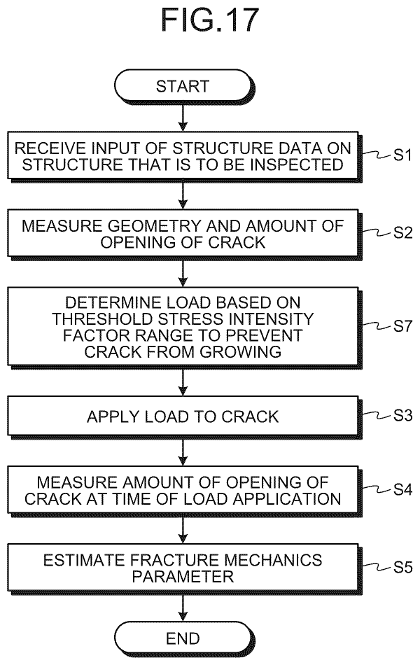

FIG. 17 is a flowchart for explaining the operation of the crack inspection apparatus 1-2 illustrated in FIG. 16. The input unit 2 of the crack inspection apparatus 1-2 receives the input of structure data indicating characteristics of a structure that is to be inspected (step S1). The structure data includes, for example, material data indicating the material of the structure that is to be inspected. Next, using the geometry measuring unit 3, the crack inspection apparatus 1-2 measures the geometry and the amount of opening of a crack that has occurred in the structure that is to be inspected (step S2).

The load determination unit 8 of the crack inspection apparatus 1-2 determines, based on the threshold stress intensity factor range ΔKₜₕ, a load to be applied to the crack so as to prevent the crack from growing (step S7). The load determination unit 8 notifies the load application unit 4 of the determined load. Next, using the load application unit 4, the crack inspection apparatus 1-2 applies the load determined by the load determination unit 8 to the crack (step S3). With the load applied to the crack, the crack inspection apparatus 1-2 measures the amount of opening of the crack at the time of load application, using the opening amount measuring unit 5 (step S4). The estimation unit 6 of the crack inspection apparatus 1 estimates the effective stress intensity factor range as a fracture mechanics parameter indicating the state of the crack (step S5).

By including the load determination unit 8, the crack inspection apparatus 1-2 can apply a load in a range not allowing the growth of a crack that is to be inspected, in addition to the effects of the crack inspection apparatus 1. This can prevent the state of the crack from deteriorating due to the inspection, and increase the accuracy of evaluation of the crack growth inhibition effect.

In the above description, the crack inspection apparatus 1-1 including the determination unit 7 has been described as the first modification, and the crack inspection apparatus 1-2 including the load determination unit 8 has been described as the second modification. However, the crack inspection apparatus 1 may include both the determination unit 7 and the load determination unit 8.

### Second Embodiment

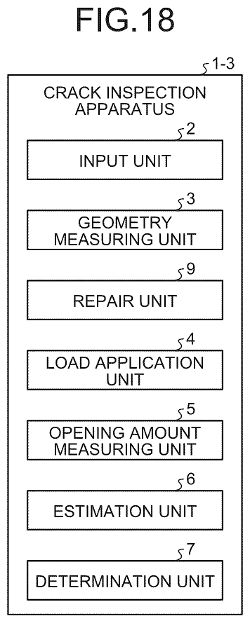

FIG. 18 is a diagram illustrating a functional configuration of a crack inspection apparatus 1-3 according to a second embodiment. The crack inspection apparatus 1-3 includes the input unit 2, the geometry measuring unit 3, a repair unit 9, the load application unit 4, the opening amount measuring unit 5, the estimation unit 6, and the determination unit 7. The crack inspection apparatus 1-3 includes the determination unit 7 and the repair unit 9 in addition to the configuration of the crack inspection apparatus 1. The following mainly describes the difference from the crack inspection apparatus 1, and omits the detailed description of the same components as those of the crack inspection apparatus 1 in the first embodiment.

The determination unit 7 is the same as the determination unit 7 of the crack inspection apparatus 1-1 according to the first modification of the first embodiment. The repair unit 9 performs growth inhibition treatment to inhibit the growth of the crack occurred in the structure to be inspected.

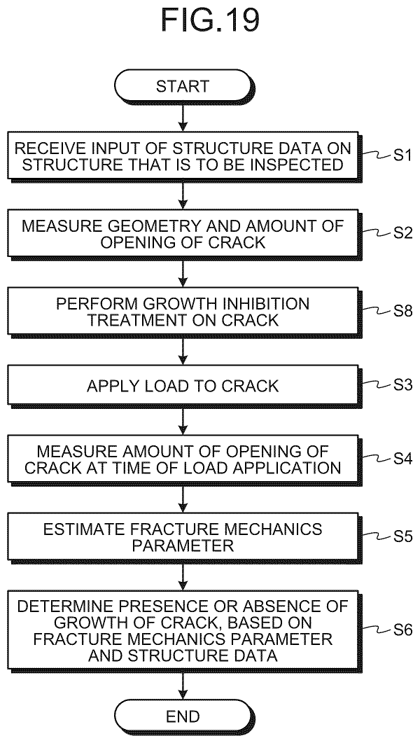

FIG. 19 is a flowchart for explaining the operation of the crack inspection apparatus 1-3 illustrated in FIG. 18. The input unit 2 of the crack inspection apparatus 1-3 receives the input of structure data indicating characteristics of a structure that is to be inspected (step S1). The structure data includes, for example, material data indicating the material of the structure that is to be inspected. Next, using the geometry measuring unit 3, the crack inspection apparatus 1-3 measures the geometry and the amount of opening of a crack occurred in the structure to be inspected (step S2).

Using the repair unit 9, the crack inspection apparatus 1-3 performs the growth inhibition treatment on the crack (step S8). Next, using the load application unit 4, the crack inspection apparatus 1-3 applies a predetermined load to the crack having been subjected to the growth inhibition treatment (step S3). With the load applied to the crack, the crack inspection apparatus 1-3 measures the amount of opening of the crack at the time of load application, using the opening amount measuring unit 5 (step S4). The estimation unit 6 of the crack inspection apparatus 1-3 estimates the effective stress intensity factor range as a fracture mechanics parameter indicating the state of the crack (step S5).

The determination unit 7 of the crack inspection apparatus 1-3 determines the presence or absence of the growth of the crack, based on the fracture mechanics parameter estimated by the estimation unit 6 and the structure data received by the input unit 2 (step S6).

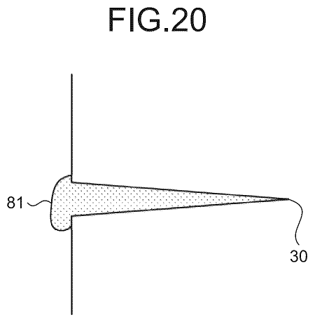

The growth inhibition treatment performed by the repair unit 9 will be described. FIG. 20 is an explanatory diagram of the growth inhibition treatment performed by the repair unit 9 illustrated in FIG. 18. The repair unit 9 applies a repair material 81 in paste form to a surface of the structure that is to be inspected, in which structure the crack 30 has occurred. The repair material 81 in paste form contains fine particles and a fluid. The fine particles contained in the repair material 81 are desirably a high-hardness substance such as alumina, iron, silica, zirconia, silicon carbide, boron carbide, or diamond. The fluid contained in the repair material 81 is desirably a liquid having fluidity such as a low-volatile oil or a flame-resistant oil. The high-hardness particles present in the crack 30 hinders the opening and closing of the crack 30, inhibiting the growth of the crack 30. Further, even when the crack grows, the fluid mixed with the fine particles transports the fine particles to the tip of the crack 30, so that the crack closure phenomenon due to the wedge effect is maintained. To prevent the repair material 81 from flowing out of the crack due to the influence of its own weight, it is effective to seal the repair material 81, using a masking tape or the like.

Although an example of the repair material 81 in paste form has been described in FIG. 20, the repair unit 9 may use any repair method as long as the repair method causes the wedge effect to hinder the opening and closing of the crack 30 to appear. For example, the repair unit 9 may inject resin into the crack 30 instead of applying the repair material 81 in paste form. The repair method using resin can also reduce the load range contributing to the growth of the crack 30 by the crack closure phenomenon due to the wedge effect, to inhibit the growth of the crack 30.

As described above, the crack inspection apparatus 1-3 according to the second embodiment performs the growth inhibition treatment on a crack that is to be inspected, and then estimates the fracture mechanics parameter, based on the relationship between the amount of opening measured with a load applied to the crack and the load. Thus, the crack inspection apparatus 1-3 achieves the effect of checking the inhibition effect of the growth inhibition treatment on the spot, in addition to the effects of the crack inspection apparatus 1 according to the first embodiment. The crack inspection apparatus 1-3 includes the repair unit 9 that performs the growth inhibition treatment, the estimation unit 6 that estimates the fracture mechanics parameter, based on the relationship between the amount of opening measured with the load applied to the crack having been subjected to the growth inhibition treatment and the load, and the determination unit 7 that determines the presence or absence of the growth of the crack, based on the result of the estimation made by the estimation unit 6. Consequently, since the presence or absence of the growth of the crack can be determined after the growth inhibition treatment is performed, the presence or absence of the necessity of additional repair can be determined, and the repair work load can be reduced.

### (First Modification)

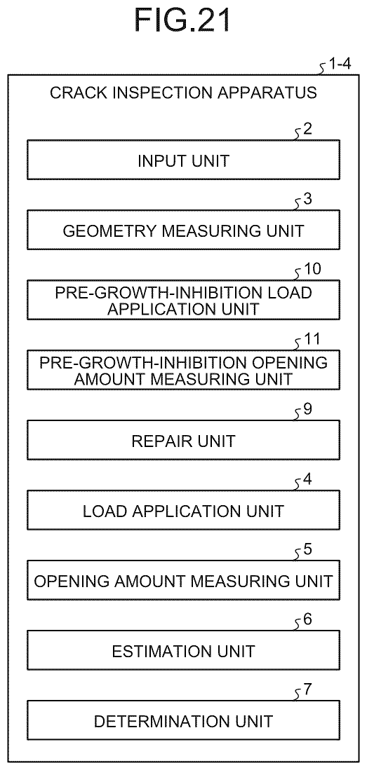

FIG. 21 is a diagram illustrating a functional configuration of a crack inspection apparatus 1-4 according to a first modification of the second embodiment. The crack inspection apparatus 1-4 includes the input unit 2, the geometry measuring unit 3, a pre-growth-inhibition load application unit 10, a pre-growth-inhibition opening amount measuring unit 11, the repair unit 9, the load application unit 4, the opening amount measuring unit 5, the estimation unit 6, and the determination unit 7. The crack inspection apparatus 1-4 includes the pre-growth-inhibition load application unit 10 and the pre-growth-inhibition opening amount measuring unit 11 in addition to the configuration of the crack inspection apparatus 1-3 according to the second embodiment. The following mainly describes the difference from the crack inspection apparatus 1-3. The pre-growth-inhibition load application unit 10 applies the load to the crack in the same way as the load application unit 4. The pre-growth-inhibition opening amount measuring unit 11 measures the amount of opening of the crack in the same way as the opening amount measuring unit 5. The pre-growth-inhibition opening amount measuring unit 11 is an example of a pre-growth-inhibition loaded crack information acquisition unit that acquires pre-growth-inhibition loaded crack information indicating the amount of opening of the crack with the load applied to the crack prior to being subjected to the growth inhibition treatment.

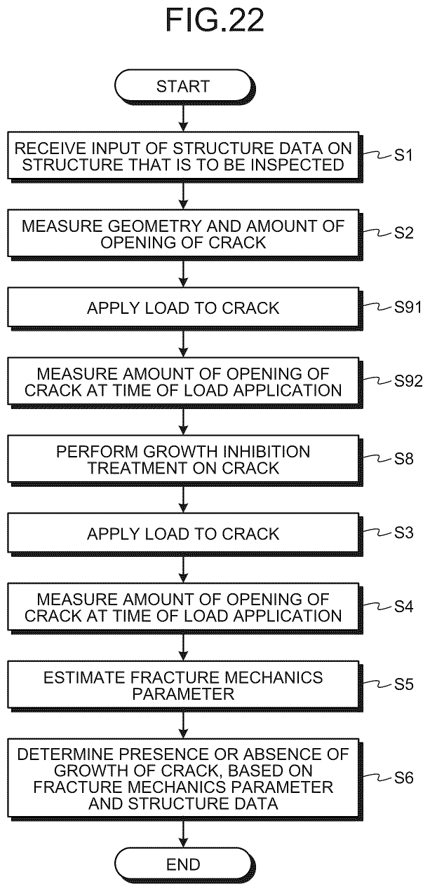

FIG. 22 is a flowchart for explaining the operation of the crack inspection apparatus 1-4 illustrated in FIG. 21. The input unit 2 of the crack inspection apparatus 1-4 receives the input of structure data indicating characteristics of a structure that is to be inspected (step S1). The structure data includes, for example, material data indicating the material of the structure that is to be inspected. Next, using the geometry measuring unit 3, the crack inspection apparatus 1-4 measures the geometry and the amount of opening of a crack occurred in the structure that is to be inspected (step S2).

The crack inspection apparatus 1-4 applies a predetermined load to the crack, using the pre-growth-inhibition load application unit 10 (step S91). With the load applied to the crack, the crack inspection apparatus 1-4 measures the amount of opening of the crack at the time of load application, using the pre-growth-inhibition opening amount measuring unit 11 (step S92). The processing in steps S91 and S92, which is also referred to as pre-growth-inhibition measurement processing, is performed before the repair unit 9 performs the growth inhibition treatment.

After the pre-growth-inhibition measurement processing, the crack inspection apparatus 1-4 performs the growth inhibition treatment on the crack, using the repair unit 9 (step S8). Next, using the load application unit 4, the crack inspection apparatus 1-4 applies the predetermined load to the crack after the growth inhibition treatment (step S3). With the load applied to the crack, the crack inspection apparatus 1-4 measures the amount of opening of the crack at the time of load application, using the opening amount measuring unit 5 (step S4). The estimation unit 6 of the crack inspection apparatus 1-4 estimates the effective stress intensity factor range as a fracture mechanics parameter indicating the state of the crack (step S5).

The determination unit 7 of the crack inspection apparatus 1-4 determines the presence or absence of the growth of the crack, based on the fracture mechanics parameter estimated by the estimation unit 6 and the structure data received by the input unit 2 (step S6).

By including the pre-growth-inhibition load application unit 10 and the pre-growth-inhibition opening amount measuring unit 11, the crack inspection apparatus 1-4 can actually measure the relationship between the amount of opening of the crack and the load applied to the crack before performing the growth inhibition treatment. This relationship is the relationship represented by the straight line L2 illustrated in FIGS. 11 to 13 if no object is present in the crack before the growth inhibition treatment is performed. Thus, in step S5 of FIG. 22, the estimation unit 6 in the crack inspection apparatus 1-4 can calculate the crack opening load Pₒₚ, using data obtained by synchronizing the amount of opening measured in step S92 with the applied load in time series.

As described above, the crack inspection apparatus 1-4 according to the first modification of the second embodiment measures the amount of opening with the load applied to the crack before the repair unit 9 performs the growth inhibition treatment on the crack. Consequently, the relationship between the amount of opening of the crack and the load applied to the crack when no object is present in the crack can be actually measured. When the predetermined load Pₜₕ is smaller than the crack opening load Pₒₚ, the crack inspection apparatuses 1, 1-1, and 1-2 according to the first embodiment and the crack inspection apparatus 1-3 according to the second embodiment need to create an analysis model and calculate the relationship between the amount of opening and the load indicated by the straight line L2 from structural analysis results, whereas the crack inspection apparatus 1-4 can reduce such work load of analysis model creation and structural analysis. Furthermore, since the straight lines L1 and L2 can be actually measured, the accuracy of estimation of the crack opening load Pₒₚ can be increased, and the accuracy of evaluation of the crack growth inhibition effect can be increased.

### Third Embodiment

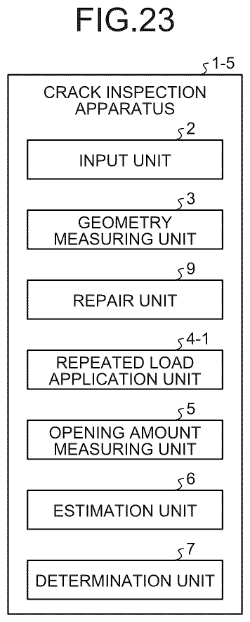

FIG. 23 is a diagram illustrating a functional configuration of a crack inspection apparatus 1-5 according to a third embodiment. The crack inspection apparatus 1-5 includes the input unit 2, the geometry measuring unit 3, the repair unit 9, a repeated load application unit 4-1, the opening amount measuring unit 5, the estimation unit 6, and the determination unit 7. The crack inspection apparatus 1-5 includes the repeated load application unit 4-1 instead of the load application unit 4 of the crack inspection apparatus 1-3 according to the second embodiment. The following mainly describes the difference from the crack inspection apparatus 1-3 according to the second embodiment. The repeated load application unit 4-1 repeatedly applies the predetermined load to the crack. Repeated load application means that a state in which the load is applied to the crack alternates with a state in which the applied load is removed. For example, when the structure that is to be inspected is a bridge, repeated load application can be achieved by causing an inspection vehicle to repeatedly travel on the bridge. The repeated load application unit 4-1 repeatedly applies the load to the crack after the repair unit 9 performs the crack growth inhibition treatment.

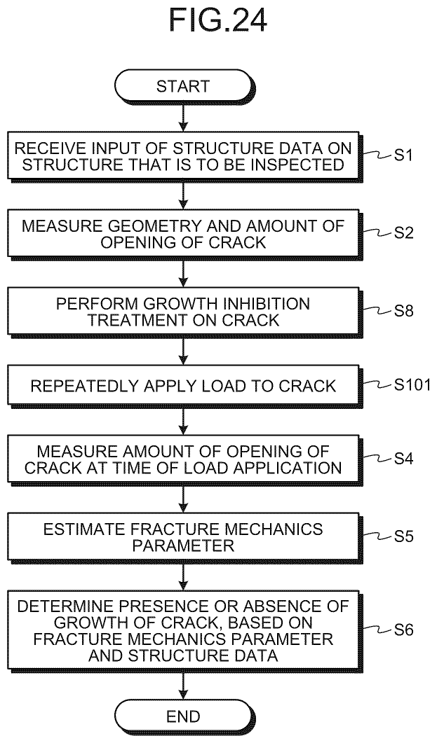

FIG. 24 is a flowchart for explaining the operation of the crack inspection apparatus 1-5 illustrated in FIG. 23. The input unit 2 of the crack inspection apparatus 1-5 receives the input of structure data indicating characteristics of a structure that is to be inspected (step S1). The structure data includes, for example, material data indicating the material of the structure that is to be inspected. Next, using the geometry measuring unit 3, the crack inspection apparatus 1-5 measures the geometry and the amount of opening of a crack occurred in the structure that is to be inspected (step S2).

Using the repair unit 9, the crack inspection apparatus 1-5 performs the growth inhibition treatment on the crack (step S8). Next, using the repeated load application unit 4-1, the crack inspection apparatus 1-5 repeatedly applies a predetermined load to the crack having been subjected to the growth inhibition treatment (step S101). With the load applied to the crack, the crack inspection apparatus 1-5 measures the amount of opening of the crack at the time of load application, using the opening amount measuring unit 5 (step S4). The estimation unit 6 of the crack inspection apparatus 1-5 estimates the effective stress intensity factor range as a fracture mechanics parameter indicating the state of the crack (step S5).

The determination unit 7 of the crack inspection apparatus 1-5 determines the presence or absence of the growth of the crack, based on the fracture mechanics parameter estimated by the estimation unit 6 and the structure data received by the input unit 2 (step S6).

FIG. 24 is the same as FIG. 19 except that FIG. 24 includes step S101 to repeatedly apply the load to the crack instead of step S3 in FIG. 19.

When the repeated load application unit 4-1 repeatedly applies the load to the crack after the performance of the growth inhibition treatment that applies the repair material 81 having the fine particles mixed with the fluid, the fine particles are transported to the tip of the crack by the repeated opening and closing of the crack, which increases the crack growth inhibition effect. The relationship between the number of repetitions of load application and the crack growth inhibition effect will be considered.

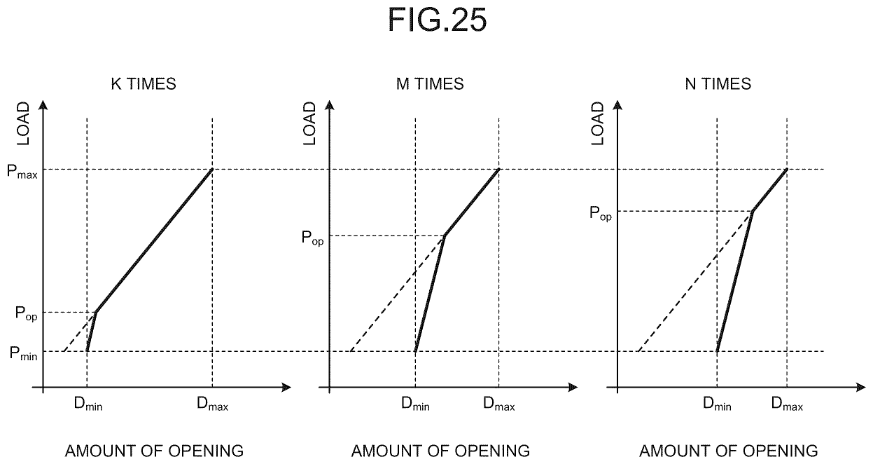

FIG. 25 is a diagram illustrating the relationships between the numbers of repetitions of load application performed by the repeated load application unit 4-1 in FIG. 23 and the crack growth inhibition effect. In FIG. 25, the horizontal axes represent the amount of opening, and the vertical axes represent the load. The point of change at which the relationship between the amount of opening and the load changes corresponds to the crack opening load Pₒₚ. FIG. 25 illustrates the relationships between the amount of opening and the load in the individual cases where the numbers of repetitions are K, M, and N. The relationship K<M<N holds. It can be seen that the crack opening load Pₒₚ increases as the number of repetitions increases. As the crack opening load Pₒₚ increases, the effective stress intensity factor range ΔK_{eff} decreases, and the crack growth rate “da/dN” decreases. It can be thus seen that the crack growth inhibition effect increases as the number of repetitions of load application increases. Once the fine particles are transported to the tip of the crack, the relationship between the amount of opening and the load reaches a state of equilibrium, so that the crack opening load converges to a constant value. That is, when the number of repetitions reaches a certain number or more, the crack growth inhibition effect does not further increase.

### (First Modification)

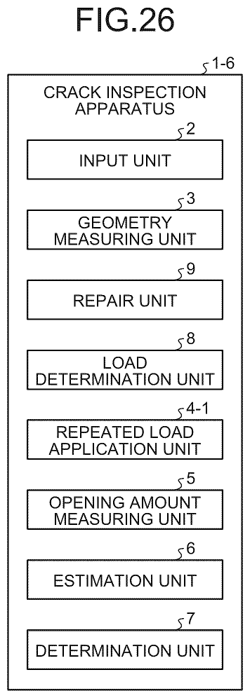

FIG. 26 is a diagram illustrating a functional configuration of a crack inspection apparatus 1-6 according to a first modification of the third embodiment. The crack inspection apparatus 1-6 includes the input unit 2, the geometry measuring unit 3, the repair unit 9, the load determination unit 8, the repeated load application unit 4-1, the opening amount measuring unit 5, the estimation unit 6, and the determination unit 7. The load determination unit 8 has the same function as the load determination unit 8 included in the crack inspection apparatus 1-2 according to the second modification of the first embodiment.

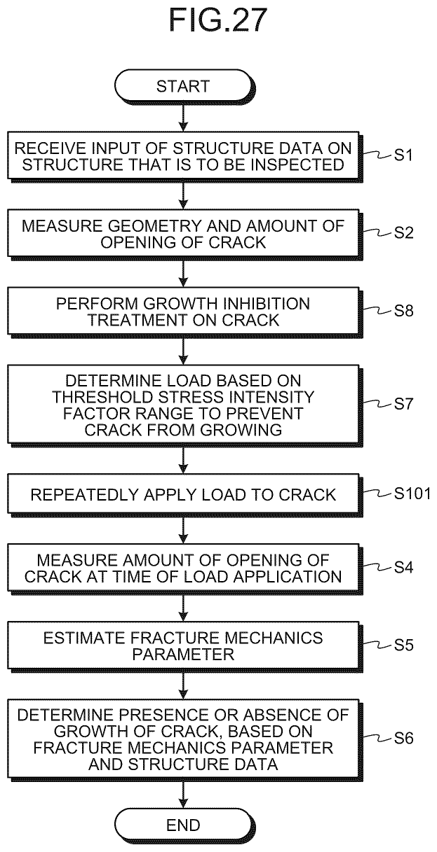

FIG. 27 is a flowchart for explaining the operation of the crack inspection apparatus 1-6 illustrated in FIG. 26. The input unit 2 of the crack inspection apparatus 1-6 receives the input of structure data indicating characteristics of a structure that is to be inspected (step S1). The structure data includes, for example, material data indicating the material of the structure that is to be inspected. Next, using the geometry measuring unit 3, the crack inspection apparatus 1-6 measures the geometry and the amount of opening of a crack that has occurred in the structure that is to be inspected (step S2).

Using the repair unit 9, the crack inspection apparatus 1-6 performs the growth inhibition treatment on the crack (step S8). The load determination unit 8 of the crack inspection apparatus 1-6 determines, based on the threshold stress intensity factor range ΔKₜₕ, a load to be applied to the crack so as to prevent the crack from growing (step S7). The load determination unit 8 notifies the repeated load application unit 4-1 of the determined load. Next, using the repeated load application unit 4-1, the crack inspection apparatus 1-6 repeatedly applies the load determined by the load determination unit 8, to the crack (step S101). With the load applied to the crack, the crack inspection apparatus 1-6 measures the amount of opening of the crack at the time of load application, using the opening amount measuring unit 5 (step S4). The estimation unit 6 of the crack inspection apparatus 1-6 estimates the effective stress intensity factor range as a fracture mechanics parameter indicating the state of the crack (step S5).

The determination unit 7 of the crack inspection apparatus 1-6 determines the presence or absence of the growth of the crack, based on the fracture mechanics parameter estimated by the estimation unit 6 and the structure data received by the input unit 2 (step S6).

Step S7 in FIG. 27 is the same as step S7 in FIG. 17. By setting the load to be applied to the crack at the time of inspection, to a value at which the crack does not grow as described above, the growth of the crack during the inspection can be inhibited even when the repeated load application unit 4-1 repeatedly applies the load, so that the growth inhibition effect by repair can be more reliably obtained. Furthermore, the repeated load application can increase the crack growth inhibition effect.

### (Second Modification)

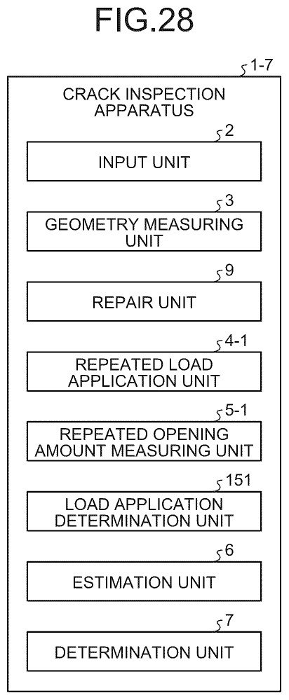

FIG. 28 is a diagram illustrating a functional configuration of a crack inspection apparatus 1-7 according to a second modification of the third embodiment. The crack inspection apparatus 1-7 includes the input unit 2, the geometry measuring unit 3, the repair unit 9, the repeated load application unit 4-1, a repeated opening amount measuring unit 5-1, a load application determination unit 151, the estimation unit 6, and the determination unit 7. The crack inspection apparatus 1-7 includes the repeated opening amount measuring unit 5-1 instead of the opening amount measuring unit 5 of the crack inspection apparatus 1-5 illustrated in FIG. 23, and further includes the load application determination unit 151. The following mainly describes the difference from the crack inspection apparatus 1-5, and the description of the same parts as those of the crack inspection apparatus 1-5 is omitted.

The repeated opening amount measuring unit 5-1 measures the amount of opening of the crack in the same way as the opening amount measuring unit 5. At this time, the repeated opening amount measuring unit 5-1 measures the amount of opening each time the repeated load application unit 4-1 applies the load. The repeated opening amount measuring unit 5-1 can output, to the load application determination unit 151, data obtained by synchronizing the measured amount of opening with the applied load data in time series. Each time the repeated opening amount measuring unit 5-1 outputs the measurement result, the load application determination unit 151 determines whether to continue the repetition of load application, from the relationship between the measured amount of opening and the load. The repeated opening amount measuring unit 5-1 can output the determination result to the repeated load application unit 4-1 and the repeated opening amount measuring unit 5-1. The repeated load application unit 4-1 operates in accordance with the determination result from the load application determination unit 151. When the determination result indicates that “the repetition is to be continued”, the repeated load application unit 4-1 continues the repetition of load application. When the determination result indicates that “the repetition is not to be continued”, the repeated load application unit 4-1 ends the repetition of load application. Similarly, the repeated opening amount measuring unit 5-1 operates in accordance with the determination result from the load application determination unit 151. When the determination result indicates that “the repetition is to be continued”, the repeated opening amount measuring unit 5-1 repeats the measurement of the amount of opening. When the determination result indicates that “the repetition is not to be continued”, the repeated opening amount measuring unit 5-1 ends the measurement of the amount of opening.

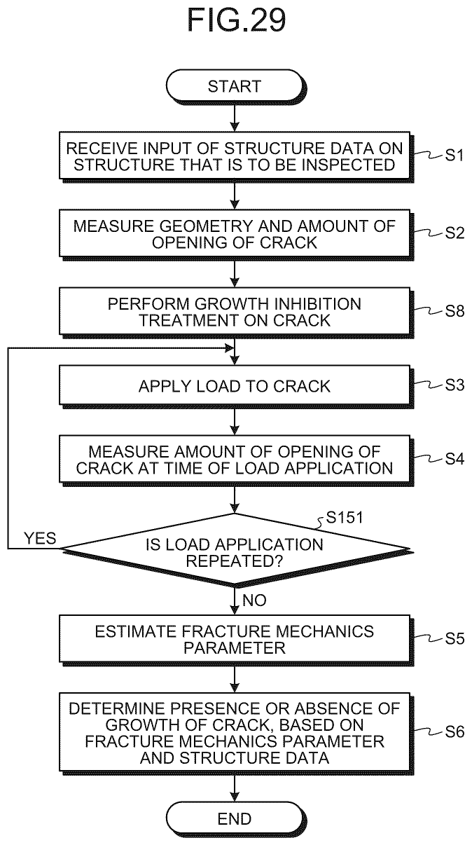

FIG. 29 is a flowchart for explaining the operation of the crack inspection apparatus 1-7 illustrated in FIG. 28. The input unit 2 of the crack inspection apparatus 1-7 receives the input of structure data indicating characteristics of a structure that is to be inspected (step S1). The structure data includes, for example, material data indicating the material of the structure that is to be inspected. Next, using the geometry measuring unit 3, the crack inspection apparatus 1-7 measures the geometry and the amount of opening of a crack occurred in the structure that is to be inspected (step S2).

The crack inspection apparatus 1-7 performs the growth inhibition treatment on the crack, using the repair unit 9 (step S8). Next, using the repeated load application unit 4-1, the crack inspection apparatus 1-7 applies a predetermined load to the crack having been subjected to the growth inhibition treatment (step S3). With the load applied to the crack, the crack inspection apparatus 1-7 measures the amount of opening of the crack at the time of load application, using the repeated opening amount measuring unit 5-1 (step S4). The load application determination unit 151 determines whether to continue the repetition of load application (step S151). When the load application determination unit 151 determines that the repetition is to be continued (step S151: Yes), the crack inspection apparatus 1-7 repeats the processing in steps S3 and S4 again. When the load application determination unit 151 determines that the repetition is not to be continued (step S151: No), the crack inspection apparatus 1-7 ends the repetition of load application, and the estimation unit 6 estimates the effective stress intensity factor range as a fracture mechanics parameter indicating the state of the crack, based on the latest measurement result in the repeated opening amount measuring unit 5-1 (step S5).

The determination unit 7 of the crack inspection apparatus 1-5 determines the presence or absence of the growth of the crack, based on the fracture mechanics parameter estimated by the estimation unit 6 and the structure data received by the input unit 2 (step S6).

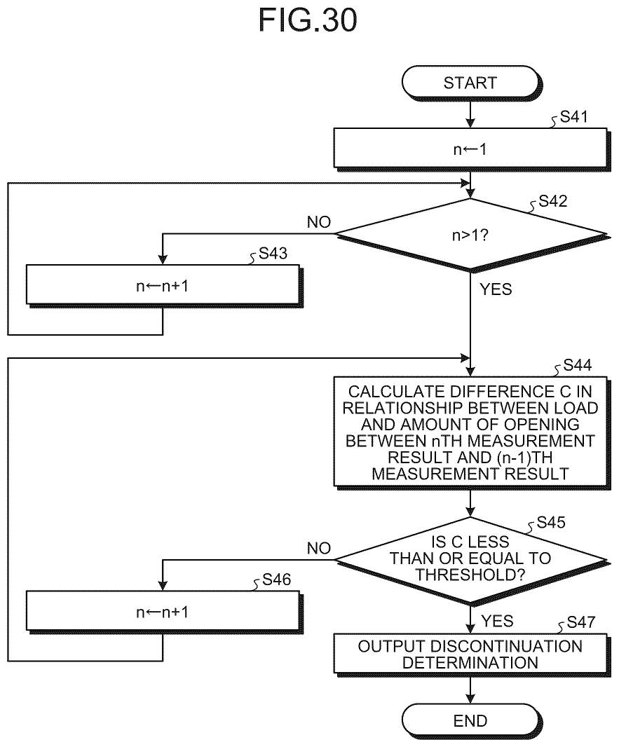

FIG. 30 is a flowchart for explaining the operation of the load application determination unit 151 illustrated in FIG. 28. The load application determination unit 151 first substitutes one for the number of repetitions n (step S41). Next, the load application determination unit 151 determines whether n is larger than one (step S42). When n is not larger than one (step S42: No), the load application determination unit 151 increments n (step S43), and repeats the processing in step S42.

When n is larger than one (step S42: Yes), the load application determination unit 151 calculates a difference C in the relationship between the load and the amount of opening between the nth measurement result and the (n−1)th measurement result (step S44). The load application determination unit 151 determines whether the calculated difference C is less than or equal to a predetermined threshold (step S45). When the difference C is not less than or equal to the threshold (step S45: No), the load application determination unit 151 increments n (step S46), and the process returns to step S44.

When the difference C is less than or equal to the threshold (step S45: Yes), the load application determination unit 151 outputs discontinuation determination, that is, a determination result indicating that the repetition of load application is not to be continued (step S47).

Since the load application determination unit 151 outputs the “discontinuation determination” and does not output a determination result when the repetition of load application is to be continued, the repeated load application unit 4-1 continues the repetition of load application until the “discontinuation determination” is input, and the repeated opening amount measuring unit 5-1 measures the amount of opening of the crack each time the load is applied. Note that the operation illustrated in FIG. 30 is an example, and any method may be used by which the load application determination unit 151 can determine that the repair material 81 in paste form has been transported to an area near the tip of the crack, and the crack opening load Pₒₚ has not changed any more.

As described above, the load application determination unit 151 of the crack inspection apparatus 1-7 determines whether to continue the repetition of load application, thereby increasing the crack growth inhibition effect, and reducing the number of repetitions of load application to a minimum as well. Consequently, the crack inspection apparatus 1-7 can shorten working hours as well as increasing the growth inhibition effect.

### Fourth Embodiment

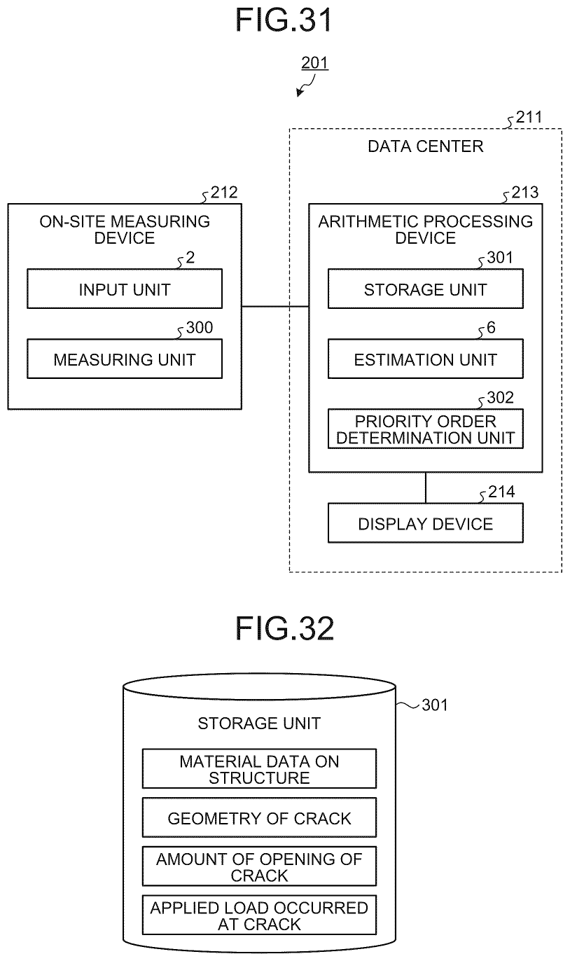

FIG. 31 is a diagram illustrating a configuration of a fatigue crack monitoring system 201 according to a fourth embodiment. The fatigue crack monitoring system 201 includes an on-site measuring device 212 used at the site where a structure to be monitored is located, and an arithmetic processing device 213 and a display device 214 installed in a data center 211.

The on-site measuring device 212 includes the input unit 2 and a measuring unit 300. The input unit 2 is the same as the input unit 2 illustrated in FIG. 1 and others. The input unit 2 of the on-site measuring device 212 acquires material data on the structure that is to be monitored. The measuring unit 300 of the on-site measuring device 212 acquires the geometry of a crack, the amount of opening of the crack, and an applied load occurred at the crack. A method by which the measuring unit 300 measures the geometry and the amount of opening of the crack is the same as the method described in the first embodiment and others. The data acquired by the on-site measuring device 212 is transmitted to the arithmetic processing device 213 in the data center 211.

The arithmetic processing device 213 includes a storage unit 301, the estimation unit 6, and a priority order determination unit 302. The storage unit 301 stores the data received from the on-site measuring device 212 and others. FIG. 32 is a diagram illustrating an example of the data stored in the storage unit 301 illustrated in FIG. 31. The storage unit 301 can store the “material data on the structure” received by the input unit 2 of the on-site measuring device 212, the “geometry of the crack” measured by the measuring unit 300 of the on-site measuring device 212, the “amount of opening of the crack” measured by the measuring unit 300 of the on-site measuring device 212, and the “applied load occurred at the crack” measured by the measuring unit 300 of the on-site measuring device 212.

The estimation unit 6 calculates the effective stress intensity factor range as a fracture mechanics parameter from the relationship between the amount of opening and the load in the same way as the estimation unit 6 illustrated in FIG. 1. Further, the estimation unit 6 uses the obtained effective stress intensity factor range to calculate the crack growth rate, using at least one of formulas (1) to (3) above. The estimation unit 6 can output the estimation result including at least the growth rate, to the display device 214 and the priority order determination unit 302.

The priority order determination unit 302 determines the priority order at the time of repair of cracks. The priority order determination unit 302 can determine the priority order for each of repair areas at the time of repair, based on the crack growth rate. For example, the priority order determination unit 302 can increase priority at the time of repair in descending order of the growth rate.

The priority order obtained by the priority order determination unit 302 is output by the display device 214. The display device 214 is an example of an output device. Information is described as being output using the display device 214, but the output device may be a printer or the like. As illustrated in FIG. 31, when the display device 214 is installed in the data center 211, the data center 211 located away from the site where there is the structure that is to be monitored can check the priority order of repair etc., and monitor the states of cracks, and when there are cracks that need repairing, instruct an on-site worker to repair the cracks, based on the output priority order.

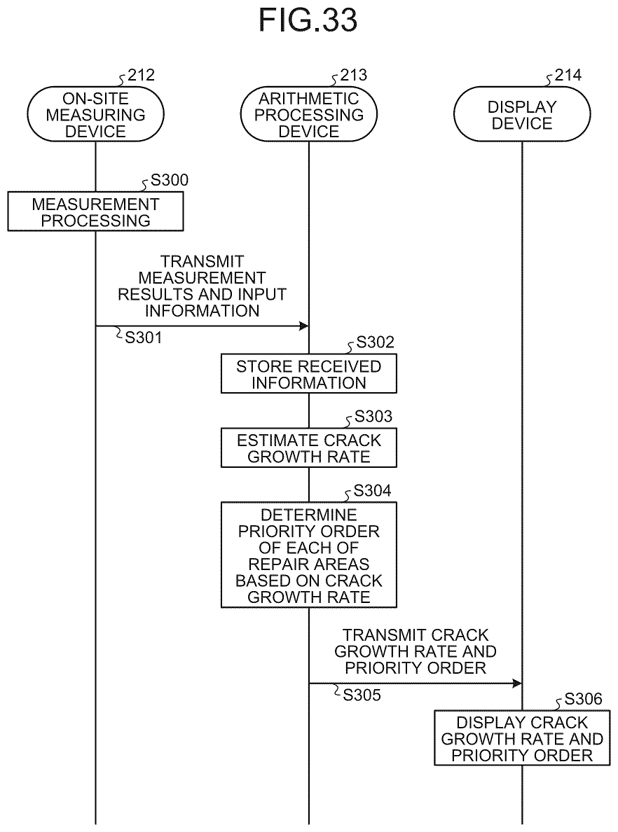

FIG. 33 is a sequence diagram for explaining the operation of the fatigue crack monitoring system 201 illustrated in FIG. 31. First, the on-site measuring device 212 performs measurement processing (step S300). This measurement processing includes processing performed by the input unit 2 to receive input information such as the material data on the structure, and processing performed by the measuring unit 300 to obtain measurement results by measuring the geometry of a crack, the amount of opening of the crack, and an applied load occurred at the crack. The on-site measuring device 212 transmits the measurement results and the input information to the arithmetic processing device 213 in the data center 211 (step S301).

The arithmetic processing device 213 stores the received information in the storage unit 301 (step S302). The estimation unit 6 of the arithmetic processing device 213 estimates the crack growth rate, using the information stored in the storage unit 301 (step S303). Next, the priority order determination unit 302 of the arithmetic processing device 213 determines the priority order of each of repair areas, based on the crack growth rate (step S304). The arithmetic processing device 213 transmits the crack growth rate and the priority order to the display device 214 (step S305).

The display device 214 displays the crack growth rate and the priority order at the time of repair (step S306).

As described above, the fatigue crack monitoring system 201 calculates the growth rate of a crack from the effective stress intensity factor range estimated in the same way as in the first to third embodiments, and determines the priority order at the time of repair of the cracks, based on the growth rate. This allows repair work to be efficiently performed from a crack having a higher crack growth rate and a higher degree of urgency of repair.

### (First Modification)

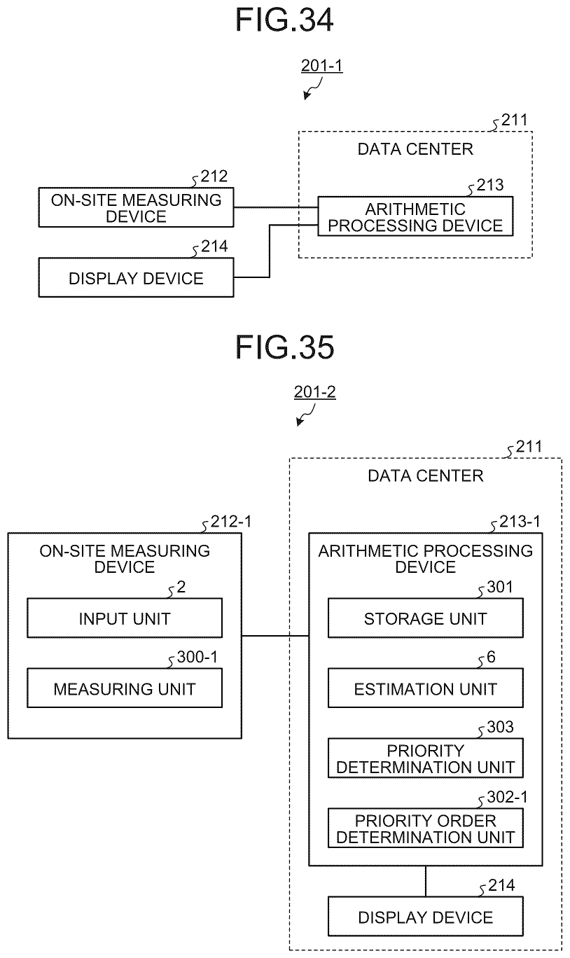

FIG. 34 is a diagram illustrating a configuration of a fatigue crack monitoring system 201-1 according to a first modification of the fourth embodiment. Similarly to the fatigue crack monitoring system 201, the fatigue crack monitoring system 201-1 includes the on-site measuring device 212, the arithmetic processing device 213, and the display device 214. In the fatigue crack monitoring system 201, the display device 214 is installed in the data center 211, whereas in the fatigue crack monitoring system 201-1, the display device 214 is located in the vicinity of the on-site measuring device 212 on the site where there is a structure that is to be monitored, which is a different point.

With the display device 214 thus provided on the site, the results of processing by the arithmetic processing device 213 can be directly output to an on-site worker. Consequently, at the time of inspection, the on-site worker can check the processing results and immediately repair a crack having a high necessity for repair.

### Fifth Embodiment

FIG. 35 is a diagram illustrating a configuration of a fatigue crack monitoring system 201-2 according to a fifth embodiment. The fatigue crack monitoring system 201-2 includes an on-site measuring device 212-1, an arithmetic processing device 213-1, and the display device 214. The on-site measuring device 212-1 is located on the site where there is a structure that is to be monitored. The arithmetic processing device 213-1 and the display device 214 are located in the data center 211.

The on-site measuring device 212-1 has the function of a measuring unit 300-1 to acquire crack occurrence position information, in addition to the functions of the on-site measuring device 212. For example, the measuring unit 300-1 can divide the structure that is to be monitored, into a plurality of sections in advance, and indicate the crack occurrence position information by section. Information transmitted by the on-site measuring device 212-1 to the arithmetic processing device 213-1 in the data center 211 is the same as the information transmitted by the on-site measuring device 212 to the arithmetic processing device 213 except that the measurement results include the crack occurrence position information.

The arithmetic processing device 213-1 includes the storage unit 301, the estimation unit 6, a priority determination unit 303, and a priority order determination unit 302-1. The priority determination unit 303 determines the priorities of cracks, based on the crack occurrence position information and determination section information stored in advance in the storage unit 301. The determination section information is information indicating predetermined priority for each of the plurality of sections into which the structure that is to be monitored has been divided in advance. For example, the determination section information may be information indicating that some of the sections are increased in priority, or may be information that classifies every section to one of a plurality of priorities. The priority determination unit 303 determines priority for each crack, based on the crack position information. The priority determination unit 303 can output the determination results to the priority order determination unit 302-1.

The priority order determination unit 302-1 determines the priority order of the crack at the time of repair for each repair area, based on the crack growth rate estimated by the estimation unit 6 and the determination result from the priority determination unit 303.

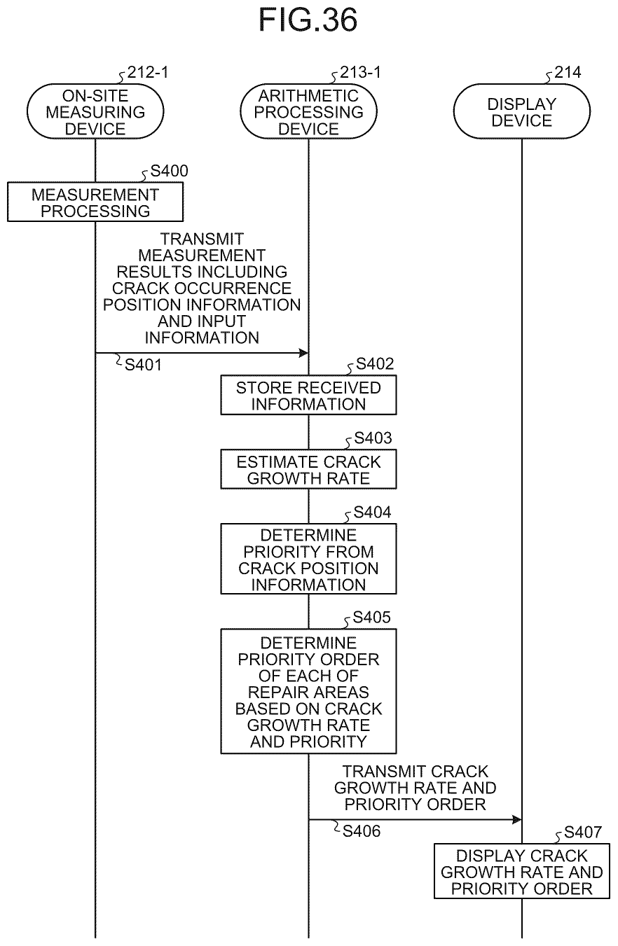

FIG. 36 is a sequence diagram for explaining the operation of the fatigue crack monitoring system 201-2 illustrated in FIG. 35. The on-site measuring device 212-1 performs measurement processing (step S400). The measurement processing in step S400 includes processing to measure crack position information in addition to the details of the measurement processing in step S300 in FIG. 33. The on-site measuring device 212-1 transmits, to the arithmetic processing device 213-1, the measurement results including the crack occurrence position information and the input information (step S401).

The arithmetic processing device 213-1 stores the received information in the storage unit 301 (step S402). The estimation unit 6 of the arithmetic processing device 213-1 estimates the crack growth rate, using the information stored in the storage unit 301 (step S403). The processing in step S403 is the same as the processing in step S303 in FIG. 33. Next, the priority determination unit 303 of the arithmetic processing device 213-1 determines the priority of repair of the crack from the crack position information (step S404). Specifically, based on the priority determined in advance for each section in the structure that is to be monitored, the priority determination unit 303 can set the priority determined in advance for the section to which the crack position information belongs, as the priority of repair of the crack. Further, the priority order determination unit 302-1 of the arithmetic processing device 213-1 determines the priority order of each of repair area, based on the crack growth rate and the priority (step S405). The arithmetic processing device 213-1 transmits the crack growth rate and the priority order to the display device 214 (step S406).

The display device 214 displays the crack growth rate and the priority order at the time of repair (step S407).

### (First Modification)

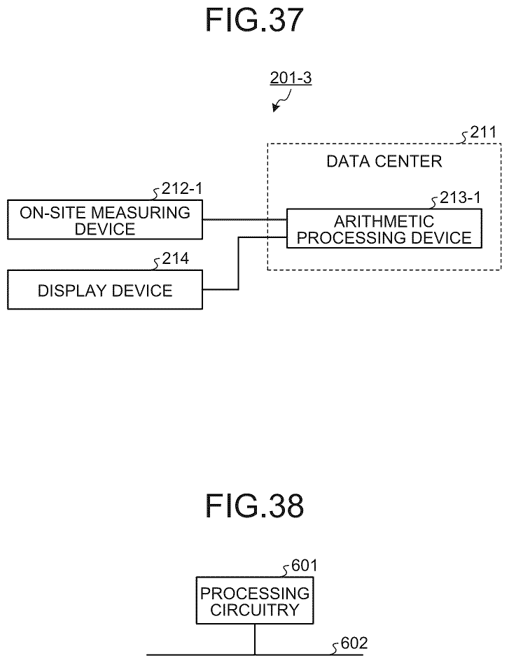

FIG. 37 is a diagram illustrating a configuration of a fatigue crack monitoring system 201-3 according to a first modification of the fifth embodiment. The fatigue crack monitoring system 201-3 includes the on-site measuring device 212-1, the arithmetic processing device 213-1, and the display device 214. In the fatigue crack monitoring system 201-2, the display device 214 is installed in the data center 211, whereas in the fatigue crack monitoring system 201-3, the display device 214 is located in the vicinity of the on-site measuring device 212-1 on the site where a structure to be monitored is located, which is a different point.

Description is given of an example of a hardware configuration for implementing the functions of each of the crack inspection apparatuses 1 and 1-1 to 1-7 and the fatigue crack monitoring systems 201 and 201-1 to 201-3 described in the first to fifth embodiments.

FIG. 38 is a diagram for explaining a first example of a hardware configuration of each of the crack inspection apparatuses 1 and 1-1 to 1-7 and the fatigue crack monitoring systems 201 and 201-1 to 201-3. The functions of each of the crack inspection apparatuses 1 and 1-1 to 1-7 and the fatigue crack monitoring systems 201 and 201-1 to 201-3 can be implemented using processing circuitry 601 as illustrated in FIG. 38. The processing circuitry 601 is connected to a bus 602. The processing circuitry 601 is an example of dedicated hardware, and corresponds, for example, to a single circuit, a combined circuit, a programmed processor, an application-specific integrated circuit (ASIC), a field-programmable gate array (FPGA), or a combination thereof. The functions of each of the crack inspection apparatuses 1 and 1-1 to 1-7 and the fatigue crack monitoring systems 201 and 201-1 to 201-3 may be implemented by different processing circuitries 601 for the individual functional blocks illustrated in the drawings, or functions indicated by a plurality of functional blocks may be collectively implemented by one processing circuitry 601.

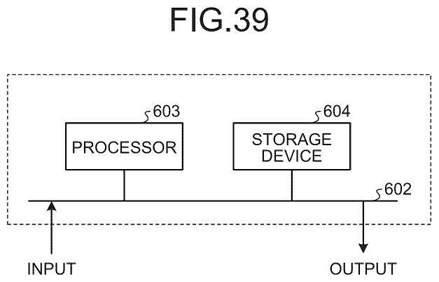

FIG. 39 is a diagram for explaining a second example of a hardware configuration of each of the crack inspection apparatuses 1 and 1-1 to 1-7 and the fatigue crack monitoring systems 201 and 201-1 to 201-3. The functions of each of the crack inspection apparatuses 1 and 1-1 to 1-7 and the fatigue crack monitoring systems 201 and 201-1 to 201-3 may also be implemented using a processor 603 and a storage device 604 as illustrated in FIG. 39. The processor 603 and the storage device 604 are connected via the bus 602. The processor 603 is a central processing unit (CPU, also called a central processor, a processing device, an arithmetic device, a microprocessor, a microcomputer, a processor, or a DSP), and can read and execute programs stored in the storage device 604. In this case, the functions of each of the crack inspection apparatuses 1 and 1-1 to 1-7 and the fatigue crack monitoring systems 201 and 201-1 to 201-3 are described as programs such as software or form wear and stored in the storage device 604. That is, the crack inspection apparatuses 1 and 1-1 to 1-7 and the fatigue crack monitoring systems 201 and 201-1 to 201-3 include the storage device 604 for storing programs that result in the execution of the steps when executed by the processing circuitry. These programs can be said to cause a computer to perform the procedure or method to be performed. Here, the storage device 604 corresponds to nonvolatile or volatile semiconductor memory such as random-access memory (RAM), read-only memory (ROM), flash memory, an erasable programmable read-only memory (EPROM), or an electrically erasable programmable read-only memory (EEPROM) (registered trademark), or a magnetic disk, a flexible disk, an optical disk, a compact disc, a mini disc, a DVD, or the like.

Note that part of the functions of each of the crack inspection apparatuses 1 and 1-1 to 1-7 and the fatigue crack monitoring systems 201 and 201-1 to 201-3 may be implemented by dedicated hardware, and the other part may be implemented by software or firmware. The processing circuitry can implement the above-described functions by hardware, software, firmware, or a combination thereof.

The configurations described in the above embodiments illustrate an example, and can be combined with another known art. The embodiments can be combined with each other. The configurations can be partly omitted or changed without departing from the gist.

For example, in the first to third embodiments, the crack inspection apparatuses 1 and 1-1 to 1-7 include the geometry measuring unit 3 that measures the geometry of a crack, the load application unit 4 that applies a load to the crack, and the opening amount measuring unit 5 that measures the amount of opening of the crack to which the load is applied. However, part or all of these functions may be omitted, and the crack inspection apparatuses 1 and 1-1 to 1-7 may include a function of acquiring measurement results. In this case, in the crack inspection apparatuses 1 and 1-1 to 1-7, the crack information acquisition unit that acquires crack information indicating the geometry of a crack occurred in a structure and the loaded crack information acquisition unit that acquires loaded crack information indicating the amount of opening of the crack with a load applied to the crack can be implemented using a device for inputting measurement results to a computer, such as a communication interface, peripheral equipment, or an operating device such as a mouse or a keyboard that inputs signals to a computer according to an operator's operations.

For example, in the fourth and fifth embodiments, only the single on-site measuring device 212 or 212-1 is illustrated, but the fatigue crack monitoring systems 201, 201-1, 201-2, and 201-3 may each include a plurality of the on-site measuring devices 212 or 212-1. The data center 211 may be able to monitor the states of cracks in a plurality of structures that are to be monitored. In the fourth and fifth embodiments, the display device 214 is located in either the data center 211 or the vicinity of the on-site measuring device 212 or 212-1, but the display devices 214 may be used in both the data center 211 and the vicinity of the on-site measuring device 212 or 212-1.

For example, the priority order determination unit 302 or 302-1 and the priority determination unit 303 of the arithmetic processing device 213 or 213-1 described in the fourth and fifth embodiments may be included in the crack inspection apparatuses 1 and 1-1 to 1-7. Further, the arithmetic processing device 213 or 213-1 and the on-site measuring device 212 or 212-1 may include part of the functions of the crack inspection apparatuses 1 and 1-1 to 1-7.

In the first to fifth embodiments, the estimation unit 6 uses the stress intensity factor range as a fracture mechanics parameter, but a fracture mechanics parameter quantitatively indicating the crack growth inhibition effect is not limited to the stress intensity factor range. For example, fracture mechanics parameters such as the J value and the energy release rate may be used.

### REFERENCE SIGNS LIST

1, 1-1 to 1-7 crack inspection apparatus; 2 input unit; 3 geometry measuring unit; 4 load application unit; 4-1 repeated load application unit; 5 opening amount measuring unit; 5-1 repeated opening amount measuring unit; 6 estimation unit; 7 determination unit; 8 load determination unit; 9 repair unit; 10 pre-growth-inhibition load application unit; 11 pre-growth-inhibition opening amount measuring unit; 30 crack; 31 sensor; 32 imaging device; 41 bridge; 43 inspection vehicle; 81 repair material; 151 load application determination unit; 201, 201-1 to 201-3 fatigue crack monitoring system; 211 data center; 212, 212-1 on-site measuring device; 213, 213-1 arithmetic processing device; 214 display device; 300, 300-1 measuring unit; 301 storage unit; 302, 302-1 priority order determination unit; 303 priority determination unit; 601 processing circuitry; 602 bus; 603 processor; 604 storage device.

1. A crack inspection apparatus comprising:
structure data acquisition circuitry to acquire structure data including material data on a structure that is to be inspected;
crack information acquisition circuitry to acquire crack information indicating a geometry of a crack occurred in the structure;
loaded crack information acquisition circuitry to acquire loaded crack information indicating an amount of opening of the crack with a load applied to the crack; and
estimation circuitry to calculate a crack opening load by determining an intersection of a first straight line obtained by plotting the load and the amount of opening indicated by the loaded crack information acquired with an object present in the crack, and a second straight line obtained by plotting the load and the amount of opening indicated by the loaded crack information acquired with no object present in the crack, the crack opening load being a minimum value of the load affecting growth of the crack, and estimate an effective stress intensity factor range from a difference between a stress intensity factor when a maximum value of the load occurs at the crack and a stress intensity factor when the crack opening load occurs at the crack, based on the structure data and the crack information, the effective stress intensity factor range quantitatively indicating a growth inhibition effect on the crack.

2. The crack inspection apparatus according to claim 1, further comprising
determination circuitry to determine presence or absence of stagnation of the crack, on a basis of the effective stress intensity factor range and a threshold stress intensity factor range included in the structure data.

3. The crack inspection apparatus according to claim 1, wherein
the structure data acquisition circuitry acquires the structure data including a growth stagnation range indicating a range of the effective stress intensity factor range in which range the crack stops growing in the structure, and
the crack inspection apparatus further comprises
load determination circuitry to determine a value of the load to be applied to the crack such that the fracture mechanics parameter of the crack falls within the growth stagnation range.

4. The crack inspection apparatus according to claim 1, wherein
the crack that is to be inspected is a crack prior to being inhibited in growth,
the crack information acquisition circuitry acquires the crack information indicating the geometry and the amount of opening, of the crack prior to being subjected to growth inhibition treatment, and
the loaded crack information acquisition circuitry acquires the loaded crack information indicating the amount of opening of the crack with the load applied to the crack after the growth inhibition treatment is performed thereon.

5. The crack inspection apparatus according to claim 4, further comprising
pre-growth-inhibition loaded crack information acquisition circuitry to acquire pre-growth-inhibition loaded crack information indicating the amount of opening of the crack with the load applied to the crack prior to being subjected to the growth inhibition treatment, wherein
the estimation circuitry estimates the effective stress intensity factor range, further on a basis of the pre-growth-inhibition loaded crack information.

6. The crack inspection apparatus according to claim 4, further comprising:
repair circuitry to perform the growth inhibition treatment on the crack; and
determination circuitry to determine, on a basis of the effective stress intensity factor range and a threshold stress intensity factor range included in the structure data, presence or absence of stagnation of the crack having been subjected to the growth inhibition treatment.

7. The crack inspection apparatus according to claim 4, wherein the loaded crack information acquisition circuitry acquires the loaded crack information indicating the amount of opening of the crack measured with the load applied to the crack after the load is repeatedly applied to the crack having been subjected to the growth inhibition treatment.

8. The crack inspection apparatus according to claim 7, further comprising
repeated load application circuitry to repeatedly apply the load to the crack having been subjected to the growth inhibition treatment.

9. (canceled)

10. The crack inspection apparatus according to claim 7, wherein
the loaded crack information acquisition circuitry repeatedly acquires the loaded crack information indicating the amount of opening of the crack measured with the load applied to the crack each time the load is repeatedly applied to the crack having been subjected to the growth inhibition treatment, and
the crack inspection apparatus further comprises
repetition determination circuitry to determine whether to continue repetition of load application, on a basis of whether the crack opening load has not changed from a relationship between the measured amount of opening and the load each time the load is repeatedly applied.

11.-15. (canceled)

16. A crack monitoring system comprising:
a measuring device; and
an arithmetic processing device,
the measuring device including:
input circuitry to receive input of structure data indicating material of a structure that is to be inspected; and
measuring circuitry to measure a geometry of a crack occurred in the structure, an amount of opening of the crack, and a load applied to the structure, and
the arithmetic processing device including:
storage circuitry to store the structure data, the geometry of the crack, the amount of opening of the crack, and the load applied to the structure acquired by the measuring device,
estimation circuitry to calculate a crack opening load by determining an intersection of a first straight line obtained by plotting the load and the amount of opening measured by the measuring circuitry with an object present in the crack, and a second straight line obtained by plotting the load and the amount of opening measured by the measuring circuitry with no object present in the crack, the crack opening load being a minimum value of the load affecting growth of the crack, estimate an effective stress intensity factor range from a difference between a stress intensity factor when a maximum value of the load occurs at the crack and a stress intensity factor when the crack opening load occurs at the crack, the effective stress intensity factor range quantitatively indicating a growth inhibition effect on the crack, and estimate a growth rate of the crack from the estimated effective stress intensity factor range, on a basis of the structure data, the geometry of the crack, the amount of opening of the crack, and the load stored in the storage circuitry, and
priority order determination circuitry to determine a priority order of the crack at a time of repair thereof, on a basis of the growth rate.

17. The crack monitoring system according to claim 16, wherein
the measuring circuitry further measures a position in the structure where the crack has occurred,
the crack monitoring system further comprises
priority determination circuitry to determine a priority of the crack at the time of repair, on a basis of priority information indicating priority at the time of repair for each position in the structure, and
the priority order determination circuitry determines the priority order, on a basis of the priority and the growth rate of the crack.

18. (canceled)

19. A crack inspection apparatus comprising:
structure data acquisition circuitry to acquire structure data including material data on a structure that is to be inspected;
crack information acquisition circuitry to acquire crack information indicating a geometry of a crack occurred in the structure;
loaded crack information acquisition circuitry to acquire loaded crack information indicating an amount of opening of the crack with a load applied to the crack; and
estimation circuitry to calculate a crack opening load by determining an intersection of a first straight line obtained by plotting the load and the amount of opening indicated by the loaded crack information acquired with an object present in the crack, and a second straight line, the crack opening load being a minimum value of the load affecting growth of the crack, the second straight line being a straight line obtained based on a structural analysis model created from the structure data and the crack information and indicating a relationship between the load and the amount of opening with no object present in the crack, and estimate an effective stress intensity factor range from a difference between a stress intensity factor when a maximum value of the load occurs at the crack and a stress intensity factor when the crack opening load occurs at the crack, based on the structure data and the crack information, the effective stress intensity factor range quantitatively indicating a growth inhibition effect on the crack.

20. The crack inspection apparatus according to claim 19, further comprising
determination circuitry to determine presence or absence of stagnation of the crack, on a basis of the effective stress intensity factor range and a threshold stress intensity factor range included in the structure data.

21. The crack inspection apparatus according to claim 19, wherein
the structure data acquisition circuitry acquires the structure data including a growth stagnation range indicating a range of the effective stress intensity factor range in which range the crack stops growing in the structure, and
the crack inspection apparatus further comprises
load determination circuitry to determine a value of the load to be applied to the crack such that the fracture mechanics parameter of the crack falls within the growth stagnation range.

22. The crack inspection apparatus according to claim 19, wherein
the crack that is to be inspected is a crack prior to being inhibited in growth,
the crack information acquisition circuitry acquires the crack information indicating the geometry and the amount of opening, of the crack prior to being subjected to growth inhibition treatment, and
the loaded crack information acquisition circuitry acquires the loaded crack information indicating the amount of opening of the crack with the load applied to the crack after the growth inhibition treatment is performed thereon.

23. The crack inspection apparatus according to claim 22, further comprising
pre-growth-inhibition loaded crack information acquisition circuitry to acquire pre-growth-inhibition loaded crack information indicating the amount of opening of the crack with the load applied to the crack prior to being subjected to the growth inhibition treatment, wherein
the estimation circuitry estimates the effective stress intensity factor range, further on a basis of the pre-growth-inhibition loaded crack information.

24. The crack inspection apparatus according to claim 22, further comprising:
repair circuitry to perform the growth inhibition treatment on the crack; and
determination circuitry to determine, on a basis of the effective stress intensity factor range and a threshold stress intensity factor range included in the structure data, presence or absence of stagnation of the crack having been subjected to the growth inhibition treatment.

25. The crack inspection apparatus according to claim 22, wherein the loaded crack information acquisition circuitry acquires the loaded crack information indicating the amount of opening of the crack measured with the load applied to the crack after the load is repeatedly applied to the crack having been subjected to the growth inhibition treatment.

26. The crack inspection apparatus according to claim 25, further comprising
repeated load application circuitry to repeatedly apply the load to the crack having been subjected to the growth inhibition treatment.

27. The crack inspection apparatus according to claim 25, wherein
the loaded crack information acquisition circuitry repeatedly acquires the loaded crack information indicating the amount of opening of the crack measured with the load applied to the crack each time the load is repeatedly applied to the crack having been subjected to the growth inhibition treatment, and
the crack inspection apparatus further comprises
repetition determination circuitry to determine whether to continue repetition of load application, on a basis of whether the crack opening load has not changed from a relationship between the measured amount of opening and the load each time the load is repeatedly applied.
